(19) United States
(12) Patent Application Publication
(10) Pub. No.: US 2026/0231939 A1
(43) Pub. Date: Aug. 13, 2026

(54) ARTHROPOD CONTROL COMPOSITIONS

(71) Applicant: Firmenich SA, Satigny (CH)

(72) Inventors: Christian CHAPUIS, Satigny (CH); Francesco SANTORO, Satigny (CH); Maud REITER, Satigny (CH); Vincent HARRACA, Aland (CH); Eduardo HATANO, Meyrin (CH)

(73) Assignee: Firmenich SA, Satigny (CH)

(21) Appl. No.: 19/122,405

(22) PCT Filed: Oct. 19, 2023
(86) PCT No.: PCT/EP2023/079185

§ 371 Date: Apr. 18, 2025

(30) Foreign Application Priority Data
Oct. 21, 2022 (EP) 22203102.3

(51) Int. Cl. A01N 43/16; A01N 25/18; A01N 43/08; A01P 17/00

(52) U.S. Cl. CPC A01N 43/16; A01N 25/18; A01N 43/08; A01P 17/00

(57) ABSTRACT

The present invention relates to an arthropod control composition, methods and uses to control arthropods as well as consumer products comprising the arthropod control composition.

### TECHNICAL FIELD

The present invention relates to an arthropod control composition, methods and uses to control arthropods as well as consumer products comprising the arthropod control composition.

### BACKGROUND

Many mammals, including humans, are suffering from the action of arthropods. Some arthropods, such as for example mosquitoes and ticks, are not desirable for vertebrates such as mammals and in particular human subjects as they bite and, consequently, cause itching, transmission of diseases and/or germs or may be the cause for other diseases and/or conditions. Similarly, other pests indirectly affect human activity or society by eating, parasitizing, or destroying plant materials that are used as food, feed or raw materials. Still further pests are involved in the destruction or weakening of furniture or structures used or built by humans. These damages may directly be attributed to the arthropods or by their capability of spreading germs causing such issues.

Arthropod control compositions include active substances and when applied to skin, clothing, or other surfaces, they may discourage arthropods from landing or climbing on that surface. Arthropod control agents help preventing and controlling the outbreak of arthropod-borne diseases, such as malaria, etc.

Some of the known arthropod controlling agents and composition, however, have certain drawbacks as they can have negative effects, i.e. negative olfactive properties, such as no or bad smell, or in turn only weak arthropod controlling, in particular arthropod repelling properties.

There is a need to identify further compounds that allow the efficient control of arthropods.

### BRIEF DESCRIPTION OF THE FIGURES

FIG. 1. Percentage of repellence of mosquitoes Aedes aegypti landing on the warm body baited with 40 μg of C₁₀ γ-lactones of different chain lengths. Each point represents the mosquito repellence elicited by a saturated γ-lactone (black circles) or an unsaturated γ-lactone (grey squares). The mean number of mosquito landings on the Warm Body baited with the solvent only (ethanol) was equal to 66.7±7.7 landings in two minutes.

FIG. 2. Percentage of repellence of mosquitoes Aedes aegypti landing on the warm body baited with C₁₀ γ-lactones at different concentrations. Each point represents the response to the saturated C₁₀ γ-lactone 5-hexyloxolan-2-one (black circles), and the unsaturated C₁₀ γ-lactone 5-hex-3-enyloxolan-2-one (grey squares), at thirteen different concentrations. The mean number of mosquito landings on the Warm Body baited with the solvent only (ethanol) was equal to 62.7±1.2 landings in two minutes.

FIG. 3. Percentage of repellence of mosquitoes Aedes aegypti landing on the warm body baited with C₁₀ δ-lactones at different concentrations. Each point represents the response to the saturated C₁₀ δ-lactone 6-pentyloxan-2-one (black circles), and the unsaturated C₁₀ δ-lactones 6-pent-2-enyloxan-2-one (dark grey squares) and 6-pent-3-enyloxan-2-one (light grey triangles) at thirteen different concentrations. The mean number of mosquito landings on the Warm Body baited with the solvent only (ethanol) was equal to 69.7±5.1 landings in two minutes.

FIG. 4. Percentage of repellence of mosquitoes Anopheles gambiae landing on the warm body baited with C₁₀ δ-lactones at different concentrations. Each point represents the response to the saturated C₁₀ δ-lactone 6-pentyloxan-2-one (black circles), and the unsaturated C₁₀ δ-lactones 6-pent-2-enyloxan-2-one (dark grey squares) and 6-pent-3-enyloxan-2-one (light grey triangles) at thirteen different concentrations. The mean number of mosquito landings on the Warm Body baited with the solvent only (ethanol) was equal to 69.7±5.1 landings in two minutes.

FIG. 5. Percentage of repellence of mosquitoes Aedes aegypti landing on the human forearm treated with C₁₀ δ-lactones (20% in ethanol) at different times post-application. Each point represents the mean±SD response to the saturated C₁₀ δ-lactone 6-pentyloxan-2-one (black circles), and the unsaturated C₁₀ δ-lactones 6-pent-2-enyloxan-2-one (dark grey squares) and 6-pent-3-enyloxan-2-one (light grey triangles). Untreated arm received 374, 377 and 472 mosquito landings during the 3 min testing period for the three tested compounds respectively. For the sake of human volunteers, test was stopped when repellency falls below 90% for all volunteers.

### DETAILED DESCRIPTION

The present invention provides an arthropod control composition comprising a compound selected from the group consisting of formulae

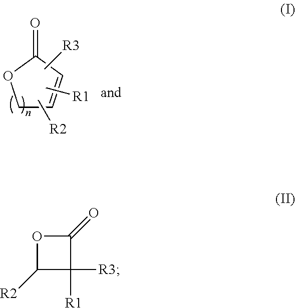

wherein R1 represents a hydrogen, or a linear or branched C₁-C₁₅ hydrocarbon group with 0-2 unsaturations;
wherein R2 represents a hydrogen, or a linear or branched C₁-C₁₅ hydrocarbon group with 0-3 unsaturations; or
wherein R1 and R2, when taken together, form a cycloalkyl-, cycloalkenyl-, or arylring that is optionally substituted with one or more methyl or ethyl groups;
wherein n is an integer of from 1 to 3;
wherein R3 represents a hydrogen, or a linear or branched C₁-C₁₅ hydrocarbon group with 0-3 unsaturations;
wherein the dotted line in formula (I) indicates that a double bond may be present in the lactone ring at any position.

The term “hydrocarbon group” refers to the normal meaning in the art, i.e. a group consisting of carbon and hydrogen atoms.

The term “unsaturation” refers to the presence of a carbon-carbon double or triple bond in a lactone side chain.

According to the invention, R1 and R2, when taken together, may form a cycloalkyl-, cycloalkenyl-, or arylring that is optionally substituted with one or more methyl or ethyl groups. In said case, the R1 and R2 groups in formula (I) are preferably attached to neighboring carbon atoms.

In a particular embodiment, R1 and R2, when taken together, do not form an arylring, in particular not a phenyl ring.

According to the invention, the dotted line in formula (I) indicates that a double bond may be present in the lactone ring at any position. Preferably, the double bond is present in the position next to the carbonyl carbon atom. In a particular embodiment, no double bond is present in the lactone ring.

The term “optionally” is understood such that a certain group to be optionally substituted can or cannot be substituted with a certain chemical group, e.g. methyl or ethyl group.

In a particular embodiment, the compound is of formula (I). In another embodiment, the compound is of formula (II).

In a particular embodiment, n is an integer of 1 or 2, preferably of 1. In another embodiment, n is an integer of 2.

In a particular embodiment, R1 and R2, R1 and R3, or R2 and R3 are present at the same carbon atom in formula (I), preferably at the carbon atom next to the ring oxygen atom. In said embodiment, the R groups being present at the same carbon atom are preferably linear or branched C₁-C₁₅ hydrocarbon groups without an unsaturation.

In a particular embodiment, at least one of R1 to R3 represents a linear C₁-C₁₅ hydrocarbon group with at least one unsaturation, preferably a linear C₄-C₈ hydrocarbon group with at least one unsaturation.

In a particular embodiment, at least one of R1 to R3 represents a linear C₁-C₁₅ hydrocarbon group with one unsaturation, preferably a linear C₄-C₈ hydrocarbon group with one unsaturation.

In a particular embodiment, at least one of R1 to R3 represents a linear C₁-C₁₅ hydrocarbon group with two unsaturations, preferably a linear C₄-C₈ hydrocarbon group with two unsaturations.

In a particular embodiment, none of R1-R3 represents a branched C₄-C₅ hydrocarbon group with at least one unsaturation.

In a particular embodiment, at least one of R1 to R3 represents a linear or branched C₁-C₁₅ hydrocarbon group with at least one unsaturation, preferably a linear or branched C₂-C₁₅ hydrocarbon group with at least one unsaturation, more preferably a linear or branched C₂-C₃ or C₆-C₁₅ hydrocarbon group with at least one unsaturation, most preferably a linear or branched C₂-C₃ or C₆-C₉ or C₁₁-C₁₅ hydrocarbon group with at least one unsaturation.

In a particular embodiment, at least one of R1 to R3 represents a linear or branched C₁-C₁₅ hydrocarbon group with two or three unsaturations, preferably a linear or branched C₂-C₁₅ hydrocarbon group with two or three unsaturations, more preferably a linear or branched C₂-C₉ or C₁₁-C₁₅ hydrocarbon group with two or three unsaturations. In particular, R2 represents a linear or branched C₁-C₁₅ hydrocarbon group with two or three unsaturations, preferably a linear or branched C₂-C₁₅ hydrocarbon group with two or three unsaturations, more preferably a linear or branched C₂-C₉ or C₁₁-C₁₅ hydrocarbon group with two or three unsaturations.

In a particular embodiment, none of R1-R3 represents a C₁₀ hydrocarbon group. In particular, R2 does not represent a C₁₀ hydrocarbon group.

In a particular embodiment, none of R1-R3 represents a decenyl group. In particular, R2 does not represent a decenyl group.

In a particular embodiment, none of R1-R3 represents a dec-1-enyl group. In particular, R2 does not represent a dec-1-enyl group.

In a particular embodiment, the compound of formula (I) is selected from the group of formulae

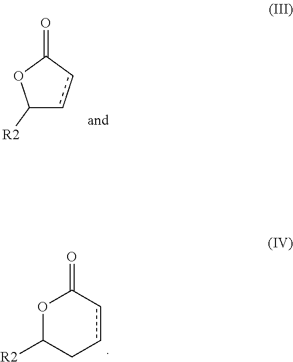

In said embodiment, R1 and R3 are hydrogens. The dotted line in formulae (Ill) and (IV) indicates that a double bond may be present in the lactone ring at any position. Preferably, the double bond is present in the position next to the carbonyl carbon atom.

In a particular embodiment, the compound of formula (I) is of formula (III). In an embodiment, a double bond is present in the lactone ring of formula (III). In another embodiment, no double bond is present in the lactone ring of formula (III). Preferably, no double bond is present in the lactone ring of formula (IV).

In a particular embodiment, the compound of formula (I) is of formula (IV). In an embodiment, a double bond is present in the lactone ring of formula (IV). In another embodiment, no double bond is present in the lactone ring of formula (IV). Preferably, no double bond is present in the lactone ring of formula (IV).

In a particular embodiment, the compound of formula (I) is selected from the group of formulae

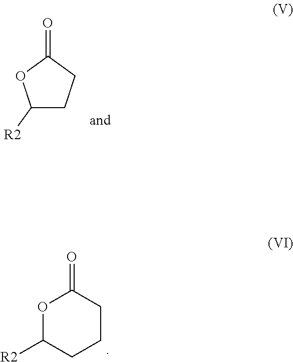

In said embodiment, R1 and R3 are hydrogens. In said embodiment, the compound does not comprise a double bond in the lactone ring.

In a particular embodiment, the compound of formula (I) is of formula (V).

In a particular embodiment, the compound of formula (I) is of formula (VI).

In a particular embodiment, R1 and R3 are hydrogens and R2 represents a linear or branched C₁-C₁₅ hydrocarbon group with from 1 to 3 unsaturations.

In a particular embodiment, R1 and R3 are hydrogens and R2 represents a linear or branched C₂-C₁₅ hydrocarbon group with from 1 to 3 unsaturations.

In a particular embodiment, R1 and R3 are hydrogens and R2 represents a linear C₂-C₁₅ hydrocarbon group with from 1 to 3 unsaturations.

In a particular embodiment, R1 and R3 are hydrogens and R2 represents a linear or branched C₁-C₁₅ hydrocarbon group with 1 unsaturation.

In a particular embodiment, R1 and R3 are hydrogens and R2 represents a linear or branched C₂-C₁₅ hydrocarbon group with 1 unsaturation.

In a particular embodiment, R1 and R3 are hydrogens and R2 represents a linear or branched C₁-C₁₅ hydrocarbon group with 2 unsaturations.

In a particular embodiment, R1 and R3 are hydrogens and R2 represents a linear or branched C₂-C₁₅ hydrocarbon group with 2 unsaturations.

In a particular embodiment, R1 and R3 are hydrogens and R2 represents a linear or branched C₁-C₁₅ hydrocarbon group with 3 unsaturations.

In a particular embodiment, R1 and R3 are hydrogens and R2 represents a linear or branched C₂-C₁₅ hydrocarbon group with 3 unsaturations.

In a particular embodiment, R1 and R3 are hydrogens and R2 represents a linear or branched C₂-C₉ or C₁₁-C₁₅ hydrocarbon group with from 1 to 3 unsaturations.

In a particular embodiment, R1 and R3 are hydrogens and R2 represents a linear or branched C₂-C₉ or C₁₁-C₁₅ hydrocarbon group with 1 unsaturation.

In a particular embodiment, R1 and R3 are hydrogens and R2 represents a linear or branched C₂-C₉ or C₁₁-C₁₅ hydrocarbon group with 2 unsaturations.

In a particular embodiment, R1 and R3 are hydrogens and R2 represents a linear or branched C₂-C₉ or C₁₁-C₁₅ hydrocarbon group with 3 unsaturations.

In a particular embodiment, R1 and R3 are hydrogens and R2 represents a linear or branched C₂-C₃, C₆-C₉, or C₁₁-C₁₅ hydrocarbon group with from 1 to 3 unsaturations.

In a particular embodiment, R1 and R3 are hydrogens and R2 represents a linear or branched C₂-C₃, C₆-C₉, or C₁₁-C₁₅ hydrocarbon group with 1 unsaturation.

In a particular embodiment, R1 and R3 are hydrogens and R2 represents a linear or branched C₂-C₃, C₆-C₉, or C₁₁-C₁₅ hydrocarbon group with 2 unsaturations.

In a particular embodiment, R1 and R3 are hydrogens and R2 represents a linear or branched C₂-C₃, C₆-C₉, or C₁₁-C₁₅ hydrocarbon group with 3 unsaturations.

In a particular embodiment, R1 and R3 are hydrogens and R2 represents a linear or branched C₈-C₁₂ hydrocarbon group with from 1 to 3 unsaturations.

In a particular embodiment, R1 and R3 are hydrogens and R2 represents a linear or branched C₈-C₁₂ hydrocarbon group with 1 unsaturation.

In a particular embodiment, R1 and R3 are hydrogens and R2 represents a linear or branched C₈-C₁₂ hydrocarbon group with 2 unsaturations.

In a particular embodiment, R1 and R3 are hydrogens and R2 represents a linear or branched C₈-C₁₂ hydrocarbon group with 3 unsaturations.

In a particular embodiment, R1 and R3 are hydrogens and R2 represents a linear or branched C₈-C₁₂ hydrocarbon group with from 1 to 3 unsaturations.

In a particular embodiment, R1 and R3 are hydrogens and R2 represents a linear or branched C₄-C₁₀ hydrocarbon group with from 1 to 3 unsaturations, preferably a C₄-C₈ hydrocarbon group.

In a particular embodiment, R1 and R3 are hydrogens and R2 represents a linear or branched C₄-C₁₀ hydrocarbon group with 1 unsaturation, preferably a C₄-C₈ hydrocarbon group.

In a particular embodiment, R1 and R3 are hydrogens and R2 represents a linear or branched C₄-C₁₀ hydrocarbon group with 2 unsaturations, preferably a C₄-C₈ hydrocarbon group.

In a particular embodiment, R1 and R3 are hydrogens and R2 represents a linear or branched C₆-C₁₀ hydrocarbon group with 3 unsaturations, preferably a C₄-C₈ hydrocarbon group.

In a particular embodiment, R1 and R3 are hydrogens and R2 represents a linear or branched C₁₀ hydrocarbon group with from 1 to 3 unsaturations.

In a particular embodiment, R1 and R3 are hydrogens and R2 represents a linear or branched C₁₀ hydrocarbon group with 1 unsaturation.

In a particular embodiment, R1 and R3 are hydrogens and R2 represents a linear or branched C₁₀ hydrocarbon group with 2 unsaturations.

In a particular embodiment, R1 and R3 are hydrogens and R2 represents a linear or branched C₁₀ hydrocarbon group with 3 unsaturations.

In a particular embodiment, R1 and R3 are hydrogens and R2 represents a C₇-C₁₀ hydrocarbon group without unsaturations. In other words, in said embodiment R2 represents a linear or branched C₇-C₁₀ alkyl group.

In a particular embodiment, the compound is selected from the group consisting of 5-propyloxolan-2-one, 5-butyloxolan-2-one, 5-pentyloxolan-2-one, 5-hexyloxolan-2-one, and any combination thereof.

In a particular embodiment, the compound is 5-propyloxolan-2-one.

In a particular embodiment, the compound is 5-butyloxolan-2-one.

In a particular embodiment, the compound is 5-pentyloxolan-2-one.

In a particular embodiment, the compound is 5-hexyloxolan-2-one.

In a particular embodiment, the compound is 5-hexyl-5-methyloxolan-2-one.

In a particular embodiment, the compound is selected from the group consisting of 5-but-3-enyloxolan-2-one, 5-pent-3-enyloxolan-2-one, 2-pentyl-2H-furan-5-one, 5-hex-1-enyloxolan-2-one, 5-hex-2-enyloxolan-2-one, 5-hex-3-enyloxolan-2-one, 5-hex-4-enyloxolan-2-one, 5-hex-5-enyloxolan-2-one, 5-oct-1-enyloxolan-2-one, 5-oct-2-enyloxolan-2-one, 5-oct-3-enyloxolan-2-one, 5-oct-4-enyloxolan-2-one, 5-[(E)-oct-5-enyl]oxolan-2-one, 5-[(Z)-oct-5-enyl]oxolan-2-one, 5-oct-6-enyloxolan-2-one, 5-oct-7-enyloxolan-2-one, 5-[(1E,5Z)-octa-1,5-dienyl]oxolan-2-one, 5-octa-1,5-dienyloxolan-2-one, 6-pent-2-enyloxan-2-one, 6-pent-3-enyloxan-2-one, 5-hexyl-5-methyloxolan-2-one, 1-oxaspiro[4.5]decan-2-one, and any combination thereof.

In a particular embodiment, the compound is selected from the group consisting of 5-but-3-enyloxolan-2-one, 5-pent-3-enyloxolan-2-one, 5-hex-1-enyloxolan-2-one, 5-hex-2-enyloxolan-2-one, 5-hex-3-enyloxolan-2-one, 5-hex-4-enyloxolan-2-one, 5-hex-5-enyloxolan-2-one, 5-oct-1-enyloxolan-2-one, 5-oct-2-enyloxolan-2-one, 5-oct-3-enyloxolan-2-one, 5-oct-4-enyloxolan-2-one, 5-[(E)-oct-5-enyl]oxolan-2-one, 5-[(Z)-oct-5-enyl]oxolan-2-one, 5-oct-6-enyloxolan-2-one, 5-oct-7-enyloxolan-2-one, 5-[(1E,5Z)-octa-1,5-dienyl]oxolan-2-one, 6-pent-2-enyloxan-2-one, 6-pent-3-enyloxan-2-one, 5-hexyl-5-methyloxolan-2-one, and any combination thereof.

In a particular embodiment, the compound is 5-but-3-enyloxolan-2-one.

In a particular embodiment, the compound is 5-pent-3-enyloxolan-2-one.

In a particular embodiment, the compound is 5-hex-1-enyloxolan-2-one.

In a particular embodiment, the compound is 5-hex-2-enyloxolan-2-one.

In a particular embodiment, the compound is 5-hex-3-enyloxolan-2-one.

In a particular embodiment, the compound is 5-hex-4-enyloxolan-2-one.

In a particular embodiment, the compound is 5-hex-5-enyloxolan-2-one.

In a particular embodiment, the compound is a mixture of 5-hex-2-enyloxolan-2-one, 5-hex-3-enyloxolan-2-one, and 5-hex-4-enyloxolan-2-one. Preferably, in amounts of 43 wt. % 5-hex-2-enyloxolan-2-one, 25 wt. % 5-hex-3-enyloxolan-2-one, and 32 wt. % 5-hex-4-enyloxolan-2-one.

In a particular embodiment, the compound is 5-oct-1-enyloxolan-2-one.

In a particular embodiment, the compound is 5-oct-2-enyloxolan-2-one.

In a particular embodiment, the compound is 5-oct-3-enyloxolan-2-one.

In a particular embodiment, the compound is 5-[(E)-oct-5-enyl]oxolan-2-one.

In a particular embodiment, the compound is 5-[(Z)-oct-5-enyl]oxolan-2-one.

In a particular embodiment, the compound is 5-oct-5-enyloxolan-2-one.

In a particular embodiment, the compound is 5-oct-6-enyloxolan-2-one.

In a particular embodiment, the compound is 5-oct-7-enyloxolan-2-one.

In a particular embodiment, the compound is 5-[(1E,5Z)-octa-1,5-dienyl]oxolan-2-one.

In a particular embodiment, the compound is 5-octa-1,5-dienyloxolan-2-one.

In a particular embodiment, the compound is 6-pent-2-enyloxan-2-one.

In a particular embodiment, the compound is 6-pent-3-enyloxan-2-one.

In a particular embodiment, the compound is selected from the group consisting of 5-but-3-enyloxolan-2-one, 5-pent-3-enyloxolan-2-one, 5-hex-1-enyloxolan-2-one, 5-hex-3-enyloxolan-2-one, 5-hex-5-enyloxolan-2-one, 5-oct-1-enyloxolan-2-one, 5-oct-2-enyloxolan-2-one, 5-oct-3-enyloxolan-2-one, 5-[(E)-oct-5-enyl]oxolan-2-one, 5-[(Z)-oct-5-enyl]oxolan-2-one, 5-oct-6-enyloxolan-2-one, 5-oct-7-enyloxolan-2-one, 5-[(1E,5Z)-octa-1,5-dienyl]oxolan-2-one, 5-octa-1,5-dienyloxolan-2-one, 6-pent-2-enyloxan-2-one, 6-pent-3-enyloxan-2-one, and any combination thereof.

In a particular embodiment, the compound is 5-but-3-enyloxolan-2-one. In a particular embodiment, the compound is 5-pent-3-enyloxolan-2-one. In a particular embodiment, the compound is 5-hex-1-enyloxolan-2-one. In a particular embodiment, the compound is 5-hex-3-enyloxolan-2-one. In a particular embodiment, the compound is 5-hex-5-enyloxolan-2-one. In a particular embodiment, the compound is 5-oct-1-enyloxolan-2-one. In a particular embodiment, the compound is 5-oct-2-enyloxolan-2-one. In a particular embodiment, the compound is 5-oct-3-enyloxolan-2-one. In a particular embodiment, the compound is 5-[(E)-oct-5-enyl]oxolan-2-one. In a particular embodiment, the compound is 5-[(Z)-oct-5-enyl]oxolan-2-one. In a particular embodiment, the compound is 5-oct-6-enyloxolan-2-one. In a particular embodiment, the compound is 5-oct-7-enyloxolan-2-one. In a particular embodiment, the compound is 5-[(1E,5Z)-octa-1,5-dienyl]oxolan-2-one. In a particular embodiment, the compound is 6-pent-2-enyloxan-2-one. In a particular embodiment, the compound is 6-pent-3-enyloxan-2-one.

In a particular embodiment, the compound is selected from the group consisting of 5-hex-3-enyloxolan-2-one, 6-pent-2-enyloxan-2-one, and 6-pent-3-enyloxan-2-one, and any combination thereof.

According to any one of the above embodiments of the invention, the compounds of formulae (I) to (VI) may possess several stereocenters and each of said stereocenter can have two different stereochemistries (e.g. R or S). The compounds of formulae (I) to (VI) may even be in the form of a pure enantiomer or in the form of a mixture of enantiomers or diastereoisomers. The compounds of formula (I) to (VI) can be in a racemic form or scalemic form. Therefore, the compounds of formula (I) to (VI) can be one stereoisomers or in the form of a composition of matter comprising, or consisting of, various stereoisomers. All structural isomers and stereoisomers are encompassed by the above-mentioned chemical compounds and structures, respectively, in particular in relation to Z/E-isomers in case of unsaturations in a side chains of the lactone ring. Hence, if not explicitly indicated, all Z/E-isomers are encompassed. Indeed, said compounds having a unsaturation can be in the form of its E or Z isomer or of a mixture thereof. In particular, the compounds according to the aforementioned formulae can be in the form of a mixture consisting of isomers E and Z and wherein said isomers E represent at least 50% of the total mixture, or even at least 75% (i.e. a mixture E/Z comprised between 75/25 and 100/0). The compounds of formulae (I) to (VI) can be a pure enantiomer or diastereomer.

In a particular embodiment, 5-hex-3-enyloxolan-2-one is (Z)-5-hex-3-enyloxolan-2-one.

In a particular embodiment, 6-pent-2-enyloxan-2-one is (6R)—(Z)-6-pent-2-enyloxan-2-one or (6S)—(Z)-6-pent-2-enyloxan-2-one.

In a particular embodiment, 6-pent-3-enyloxan-2-one is (E)-6-pent-3-enyloxan-2-one.

In a particular embodiment, the compound is 1-oxaspiro[4.5]decan-2-one.

In a particular embodiment, the compound is selected from the following group of compounds and any combinations thereof:

Compound name
(3R,4S)-3-[(1E)-buta-1,3-dienyl]-4-pentyloxetan-2-one
(3R,4R)-3-[(1E)-buta-1,3-dienyl]-4-pentyloxetan-2-one
6-[(Z)-pent-2-enyl]oxan-2-one
(6R)-6-[(Z)-pent-2-enyl]oxan-2-one
(6S)-6-[(Z)-pent-2-enyl]oxan-2-one
6-[(E)-pent-3-enyl]oxan-2-one
5-HEXYL-3,4-DIHYDRO-2H-PYRAN-2-ONE
5-HEPTYL-3,4-DIHYDRO-2H-PYRAN-2-ONE
5-octyl-3,4-dihydro-2H-pyran-2-one
(4aS,7S,7aR)-4,7-dimethyl-5,6,7,7a-tetrahydro-4aH-
cyclopenta[c]pyran-1-one
5-pentyl-3,4-dihydro-2H-pyran-2-one
5-(3/4-hexen-1-yl)-3-methyldihydro-2(3H)-furanone
5-[(Z)-hex-3-enyl]oxolan-2-one
5-hex-5-enyloxolan-2-one
5-[(E)-hex-1-enyl]oxolan-2-one
5-[(E)-hex-3-enyl]oxolan-2-one
3-butylidene-2-benzofuran-1-one
3-butylidene-2-benzofuran-1-one
5-[(Z)-oct-5-enyl]oxolan-2-one
5-[(Z)-oct-6-enyl]oxolan-2-one
5-[(1E,5Z)-octa-1,5-dienyl]oxolan-2-one
5-[(E)-oct-2-enyl]oxolan-2-one
5-oct-7-enyloxolan-2-one
5-[(E)-oct-6-enyl]oxolan-2-one
5-[(E)-oct-5-enyl]oxolan-2-one
5-[(E)-oct-3-enyl]oxolan-2-one
4,4,7a-trimethyl-3a,5-dihydro-3H-1-benzofuran-2-one
5-(1/2-buten-1-yl)-3-methyldihydro-2(3H)-furanone
5-but-3-enyloxolan-2-one
5-[3-penten-1-yl]dihydro-2(3H)-furanone
2-pentyl-2,3-dihydropyran-6-one
2-heptyl-2,3-dihydropyran-6-one
3-buta-1,3-dienyl-4-pentyloxetan-2-one
6-pent-2-enyloxan-2-one
4,7-dimethyl-5,6,7,7a-tetrahydro-4aH-cyclopenta[c]pyran-
1-one
5-hex-3-enyloxolan-2-one
5-hex-1-enyloxolan-2-one
5-oct-5-enyloxolan-2-one
5-oct-6-enyloxolan-2-one
5-octa-1,5-dienyloxolan-2-one
5-oct-2-enyloxolan-2-one
5-oct-6-enyloxolan-2-one
5-oct-5-enyloxolan-2-one
5-oct-3-enyloxolan-2-one

In a particular embodiment, the compound is selected from the following group of compound structures, and any combinations thereof:

Structure

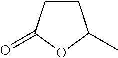

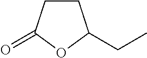

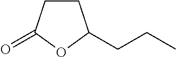

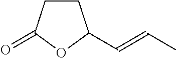

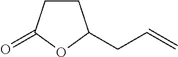

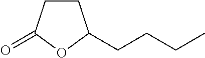

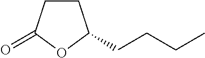

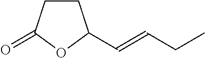

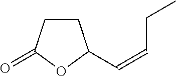

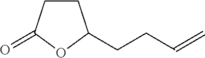

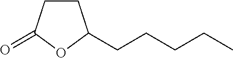

| | |
|---|---|
| 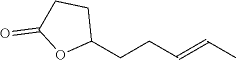 | 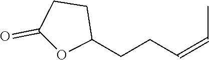 |

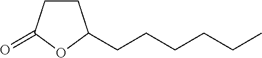

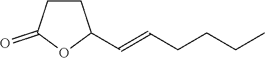

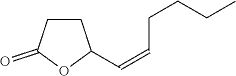

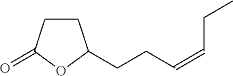

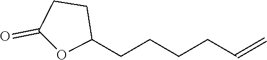

| | | |
|---|---|---|
| 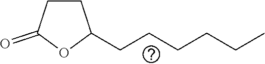 | 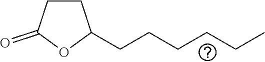 | 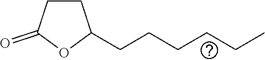 |

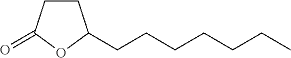

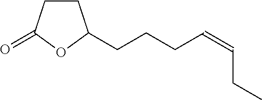

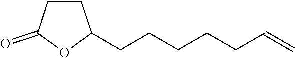

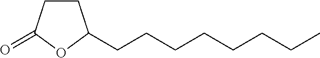

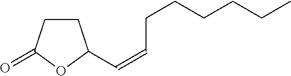

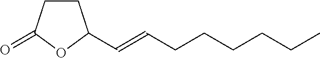

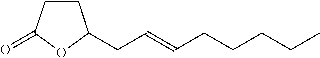

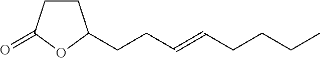

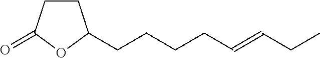

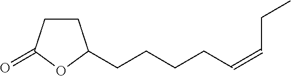

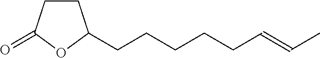

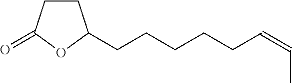

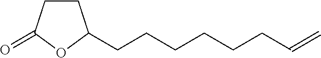

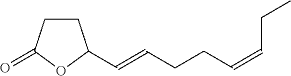

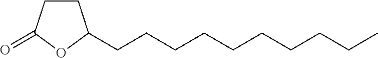 [SMILES: CCCCCCCCCCC1CCC(=O)O1]

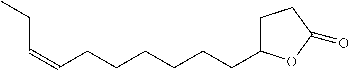 [SMILES: CC/C=C\CCCCCCC1CCC(=O)O1]

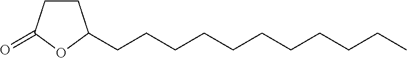 [SMILES: CCCCCCCCCCCC1CCC(=O)O1]

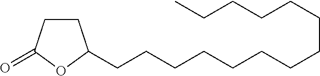 [SMILES: CCCCCCCCCCCCCCC1CCC(=O)O1]

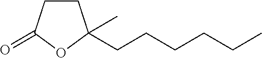

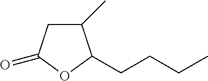

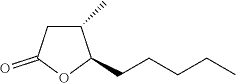

| | |
|---|---|
| 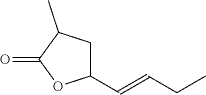 | 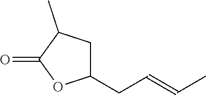 |
| 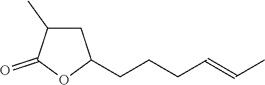 | 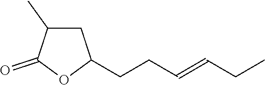 |

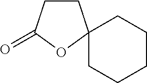 [SMILES: O=C1CCC2(CCCCC2)O1]

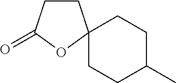

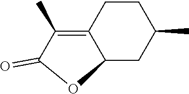

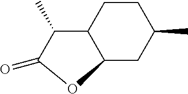

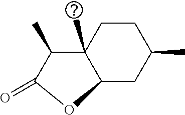

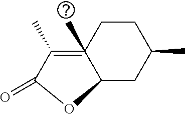

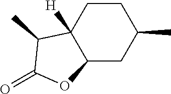

| | |
|---|---|
| 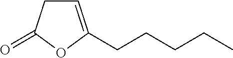 | 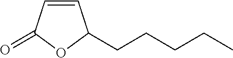 |

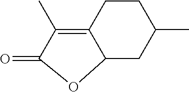

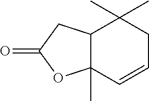

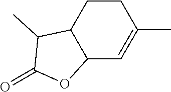

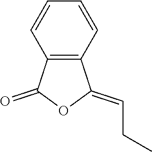

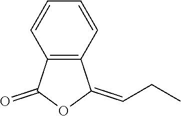

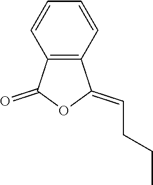

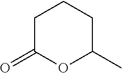

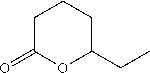

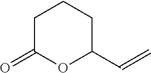

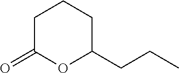

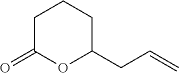

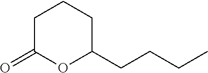

| | |
|---|---|
| 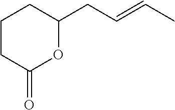 | 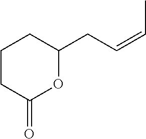 |

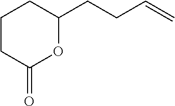

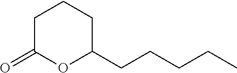

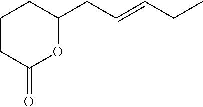

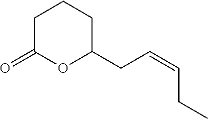

| | |
|---|---|
| 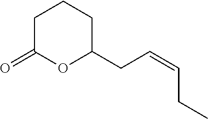 | 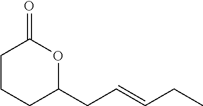 |

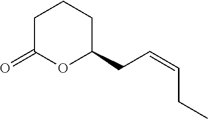

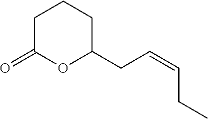

| | |
|---|---|
| 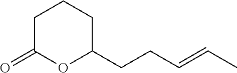 | 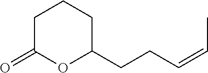 |

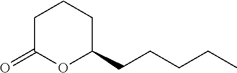

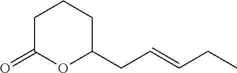

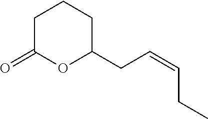

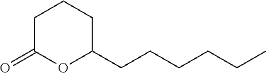

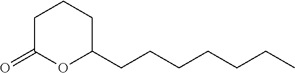

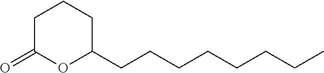

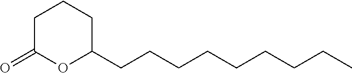 [SMILES: CCCCCCCCCC1CCCC(=O)O1]

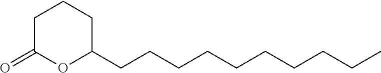 [SMILES: CCCCCCCCCCC1CCCC(=O)O1]

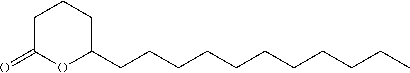 [SMILES: CCCCCCCCCCCC1CCCC(=O)O1]

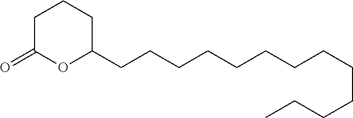 [SMILES: CCCCCCCCCCCCCC1CCCC(=O)O1]

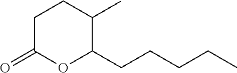

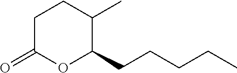

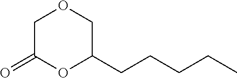

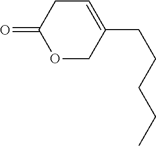

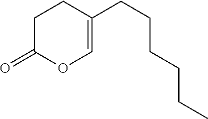

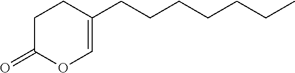

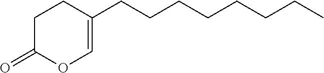

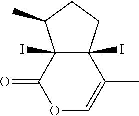

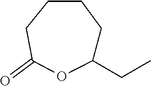

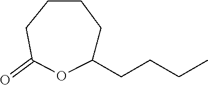

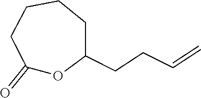

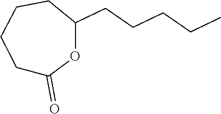

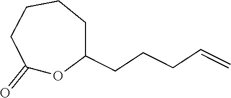

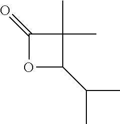

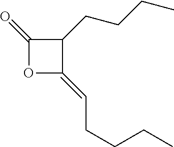

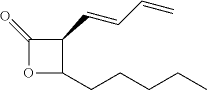

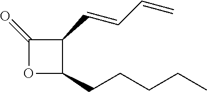

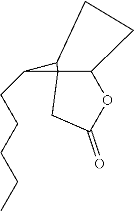

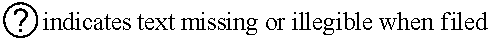

In a particular embodiment, the arthropod control composition has a good hedonic profile.

The term “arthropod” has the normal meaning for a skilled person in the technical field. Arthropods include invertebrate animals, such as insects, arachnids, and crustaceans, that have a segmented body and jointed appendages. Arthropods usually have a chitinous exoskeleton molted at intervals, and a dorsal anterior brain connected to a ventral chain of ganglia.

Arthropods in the present invention's understanding relate to undesired arthropods, meaning that their presence in the air, on the surface of an article, the surface of a plant or the surface of a vertebrate, such as a human subject or other mammal, preferably human subject, is not desired. Preferably undesired arthropods are pest arthropods that impact plants and animals, e.g. thrips, aphids, beetles, moth, mealybug, scale etc., more preferably pest arthropods that impact animals, e.g. ants, termites, cockroaches, flies, etc., even more preferably blood feeding arthropods that impact vertebrates, e.g. biting fly, bed bug, kissing bug, flea, lice, mosquitos and ticks, even more preferably mosquitos and ticks.

The reason why the presence of an arthropod is not desired might be that the arthropod's presence in the air is unpleasant to a subject, the contact of an arthropod on an article transfers diseases and/or germs or the arthropod bites an organism and causes itching, the transmission of diseases and/or germs or the arthropod feeding may be the cause for other diseases and/or conditions.

In a particular embodiment, the arthropod is an insect or an arachnid, preferably an insect.

The term “insect” has the normal understanding by a skilled person the technical field. An insect is described by a well-defined head, thorax, and abdomen, only three pairs of legs, and typically one or two pairs of wings.

In a particular embodiment, the insect is a mosquito, biting fly, bedbug, kissing bug, flea, lice, ant, termite, cockroach, fly, aphid, beetle, thrips, moth, mealybug or scale bug, more preferably a mosquito.

The term “arachnid” has the normal understanding by a skilled person the technical field. An arachnid is described having a segmented body divided into two regions of which the anterior bears four pairs of legs but no antennae.

In a particular embodiment, the arachnid is a tick, mite, chigger or spider, more preferably a tick.

The expression “control”, “arthropod control”, “insect control” or “arachnid control” or the like has the normal meaning for a skilled person in the technical field.

“Controlling” in the context of the present invention defines the ability of an arthropod controlling composition according to the present invention to attract, deter, kill or repel an arthropod, preferably deter or repel an arthropod and even more preferably repel an arthropod.

“Attracting” according to the present invention defines the ability of an arthropod attractant composition according to the invention to increase or encourage contact or the presence of an arthropod at the arthropod attractant source, such as in the air, on the surface of an article or on the surface of a vertebrate, such as a human subject or other mammal, preferably an article such as a trapping device, the arthropod attractant compound or composition has been applied to.

“Repellency” according to the present invention defines the ability of an arthropod repellent composition according to the present invention to minimize, reduce, discourage or prevent approach or the presence of an arthropod at the arthropod repellent source, such as in the air, on the surface of an article or on the surface of a vertebrate, such as a human subject or other mammal, preferably human subject, to which the arthropod repellent compound or composition has been applied to.

“Deterring” according to the present invention defines the ability of an arthropod deterrent composition according to the invention to minimize, reduce, discourage or prevent contact or the presence of an arthropod at the arthropod deterrent source, such as in the air, on the surface of an article or on the surface of a vertebrate, such as a human subject or other mammal, preferably human subject, to which the arthropod deterrent compound or composition has been applied to. Typically, the deterrent effect is shown when used as feeding deterrent hindering a pest from subsequent food intake or oviposition or physical contact after an initial tasting of the arthropod deterrent compound or composition.

“Spatial Repellency” according to the present invention defines the ability of an arthropod repellent composition according to the present invention to minimize, reduce, discourage or prevent approach or the presence of an arthropod at the arthropod repellent source, such as in the air, on the surface of an article or on the surface of an vertebrate, such as a human subject or other mammal, preferably human subject, to which the arthropod repellent compound or composition has been applied to. Typically, the spatial repellency effect is shown when spatial repellent compound or composition released, sprayed, spread or diffused in the air or liquid hinder a pest from entering the zone in which the spatial repellent compound or composition is present. Repellence occurs therefore from a distance, the pest not necessarily entering in direct contact with the treated article or organism to protect.

“Killing” according to the present invention defines the ability of arthropod killing composition according to the present invention to kill an arthropod at the arthropod killing source, such as in the air, on the surface of an article or on the surface of a vertebrate, such as a human subject or other mammal, preferably human subject, to which the arthropod killing compound or composition has been applied to. When an arthropod killing composition is applied to a plant, an animal or human subject, it is applied in an amount which is killing to the arthropod but not to the subject.

In a particular embodiment, the arthropod control composition is an undesired crawling arthropod or undesired flying arthropod control composition, preferably control composition for any organism harmful to humans or humans concern, more preferably a blood feeding arthropod control composition or a textile-attacking arthropod or a stored goods-attacking arthropod control composition, more preferably a cockroach or an ant or a termite or a bed bug or a tick or a mite or a flea or a litter beetle or a fly or a mosquito or a wasp or a hornet or a biting midge or a moth or a silverfish or a fly on livestock or a fruit fly or a scuttle fly or a stable fly or a lice or a kissing bug or a midge or a moth or a beetle control composition.

In a particular embodiment, the arthropod control composition is a blood feeding arthropods control composition, preferably a Aedes spp. or Anopheles spp. or Culex spp. or Simulium spp. or Ixodes spp or Rhipicephalus spp. or Amblyomma spp. or Argas spp. or Ornithodoros spp. or Neotrombicula spp. or Phtirus spp. or Glossina spp. or Tabanus spp. or Atylus spp. or Chrysops spp. or Haematopota spp. or Haematobia spp. or Haematobosca spp. or Stomoxys spp. or Phlebotomus spp. or Culicoides spp. or Ctenocephalides spp. or Phtirus spp. or Pediculus spp. or Triatoma spp. or Rhodnius spp. or Cimex spp. or Ixodes spp. or Rhipicephalus spp. or Amblyomma spp. or Argas spp. or Ornithodoros spp. or Neotrombicula spp. or Varroa spp. or Dermatophagoides spp. or Musca spp. or Drosophila spp. control composition.

In a particular embodiment, the arthropod control composition is an arthropod control composition, preferably an insect control composition, more preferably a Diptera control composition.

In a particular embodiment, the arthropod control composition is an Aedes spp control composition, preferably an Ae. aegypti, or Ae. albopictus control composition.

In another particular embodiment, the arthropod control composition is an Anopheles spp. control composition, preferably an An. gambiae or An. stephensis or An. quadrimatilacus or An. faruati control composition. Even more particularly, the arthropod control composition is an An. Gambiae control composition.

In another particular embodiment, the arthropod control composition is a Culex spp. control composition, preferably an C. pipiens or C. quinquefasciatus or C. modestus or C. pinaresis or C. tritaeniorhynchus or C. sitiens or C. annulirostris control composition.

In another particular embodiment, the arthropod control composition is a fly control composition, preferably a leaf-miner flies or fruit flies or gall midges or screwworm or botflird or blackflies or drainflies or house flies or stable flies or blowflies or tachnidis or biting midges or sandflies control composition, more preferably a Drosophila suzuki or Drosophila melanogaster or Bactrocera dorsalis or Ba. oleae or Ba. tryoni or Euleia heraclei or Anastrepha grandis or An. ludens or An. obliqua or An. suspensa or Strauzia longipennis or Rhagoletis mendax or Ceratitis capitata or Ce. cosyra or Ce. rosa control composition.

In another particular embodiment, the arthropod control composition is a Simuliidae control composition, preferably a Simulium damnosum or Si. naevi or Si. callidum or Si. metallicum or Si. ochraceum or Si. ornatum or Si. posticatum or Si. variegatum or Si. bezzi or Si. erythrocephalum control composition.

In another particular embodiment, the arthropod control composition is a Glossina spp. control composition, preferably a Gl austeni or Gl longipalpis or Gl morsitans or Gl pallidipes or Gl swynnertoni or Gl. brevipalpis or Gl fusca or Gl. fuscipleuris or Gl. frezili or Gl. haningtoni or Gl. longipennis or Gl. medicorum or Gl. nashi or Gl. nigrofusca or Gl. nigrofusca or Gl. severini or Gl. schwetzi or Gl. tabaniformis or Gl. vanhoofi or Gl. caliginea or Gl. fuscipes or Gl. pallicera or Gl. palpalis or Gl. tachinoides control composition. In another particular embodiment, the arthropod control composition is a Tabanidae control composition, preferably a Tabanus spp. or Atylus spp. or Chrysops spp. or Haematopota spp. control composition, more preferably a Tabanus bovinus or Ta. autumnalis or Ta. bromius or Ta. eggeri or Ta. glaucopis or Ta. sudeticus or Chrysops relictus or Haematopota crassicornis control composition.

In another particular embodiment, the arthropod control composition is a Muscidae control composition, preferably a Haematobia spp. or Haematobosca spp. or Stomoxys spp. or Drosophila spp. or Musca spp control composition, more preferably a Haematobia exigua or Stomoxys calcitrans or Musca domestica control composition.

In another particular embodiment, the arthropod control composition is a sand fly control composition, preferably Phlebotomus ariasi or Ph. balanicus or Ph. intermedius or Ph. longicuspis or Ph. papatasi or Ph. perniciosus or Ph. sergenti control composition. In another particular embodiment, the arthropod control composition is a Ceratopogonidae control composition, preferably Culicoides occidentalis or Culicoides sanguisuga or Culicoides furens or Culicoides impunctatus control composition.

In another particular embodiment, the arthropod control composition is a flea control composition, preferably Ctenocephalides felis or Ct. canis or Pulex irritans or Archeopsylla erinace control composition.

In another particular embodiment, the arthropod control composition is a lice control composition, preferably Phtirus pubis or Ph inguinalis or Pediculus humanus capitis or Pediculus humanus corporis or Liposcelis corroden or Li. decolor or Dorypteryx domestica control composition.

In another particular embodiment, the arthropod control composition is a Heteroptera control composition, preferably a kissing bug or bed bug control composition, more preferably a Triatoma infestans or Tr. barberi or Tr. dimidiate or Tr. nigromaculata or Tr. protracta or Rhodnius prolixus or Panstrongylus geniculatus or Cimex lectularius or Ci. hemipterus or Ci. dissimilis or Ci. marginatus control composition.

In another particular embodiment, the arthropod control composition is a beetle control composition, preferably a Acanthoscelides obtectus or Alphitobius diaperinus or Anobium punctatum or Anthrenus flavipes or An. munroi or An. museorum or An. pimpinellae or An. scrophulariae or An. verbasci or Attagenus unicolor or Callosobruchus maculatus or Cryptolestes ferrugineus or Cr. busillus or Dermestes lardarius or Hylotrupes bajulus or Lasioderma serricorne or Lyctus brunneus or Oryzaephilus surinamensis or Rhyzopertha dominica or Sitophilus granarius or Si. oryzae or Si. zeamais or Stegobium paniceum or Tenebrio molitor or Tenebroides mauritanicus or Tribolium castaneum or Tr. confusum or Trogoderma granarium or Tr. inclusum or Tr. longisetosum or Tr. variabilekissing control composition.

In another particular embodiment, the arthropod control composition is a moth control composition, preferably a Cadra cautella or Corcyra cephalonica or Endrosis sarcitella or Ephestia elutella or Ep. kuehniella or Hofmannophila pseudospretella or Nemapogon granella or Plodia interpunctella or Pyralis farinalis or Sitotroga cerealella control composition.

In another particular embodiment, the arthropod control composition is a cockroaches control composition, preferably a Blatta spp. or Blattella spp. or Periplaneta spp control composition, more preferably a Blatta orientalis or Blatella germanica or Periplaneta americana control composition. In another particular embodiment, the arthropod control composition is a ants control composition, preferably a Lasius spp. or Monomorium spp. or Solenopsis spp or Myrmica spp. control composition, more preferably a Monomorium pharaonis or Lasius niger or Solenopsis invicta or Myrmica rubra or Linepithema humile or Tapinoma melanocephalum or Lasius neglectus or Tapinoma erraticum control composition.

In a particular embodiment, the arthropod control composition is an Arachnida control composition, more preferably a tick control composition.

In another particular embodiment, the arthropod control composition is an Ixodes spp. control composition, preferably an I. ricinus or I. scapularis or I. persulcatus or I. pacificus or I. holocyclus or I. ovatus or I. uriae or I. hexagonus or I. acuminatus control composition.

In another particular embodiment, the arthropod control composition is an Rhipicephalus spp. control composition, preferably an R. sanguineus or R. haemaphysaloides or R. phoenix control composition.

In another particular embodiment, the arthropod control composition is an Amblyomma spp. control composition, preferably an Am. variegatum or Am. americanum or Am. testudinarium control composition.

In another particular embodiment, the arthropod control composition is an Argasidae control composition, preferably an Argas monolakensis or Ar. persicus or Ar. reflexus or Ornithodoros coriaceus or O. erraticus or O. concanensis control composition.

In another particular embodiment, the arthropod control composition is a mite control composition, preferably a Neotrombicula autumnalis or Varroa destructor or V. jacobsoni or V. rindereri or V. sinhai or Sarcoptes scabiei or Sarcoptes. spp or Dermatophagoides pteronyssinus or Dermanyssus gallinae or Ornithonyssus sylviarum or Acarus siro or Lepidoglyphus destructor or Tyrophagus longior or Tyrophagus putrescentiae control composition.

In a particular embodiment, the arthropod control composition is an agricultural pest control composition, preferably an insect or mite or nematode control composition.

In a particular embodiment, the arthropod controlling source is the surface and/or the air in the vicinity of an article, preferably a candle, coil, electric diffuser, wristband, patch, collar, ear tag, clothes, fabrics, papers, biochar, cardboard, cellulosic pads, bed nets, screen, curtains, furniture, walls, ground or paint, or the surface of a subject, preferably the surface of a vertebrate, such as a human subject or other mammal, preferably human subject, i.e. the skin of a human subject treated with a product such as spray, aerosol, cream, roll on, wristband, lotion, soap, shampoo, sunscreen or patch or a cloth treated with a product such as laundry powder, liquid detergent, spray, lotion, powder.

The arthropod controlling effect may be determined on mosquitoes using an adapted Warm Body assay as defined in Kröber T, Kessler S, Frei J, Bourquin M, Guerin P M. An in vitro assay for testing mosquito controlling compounds employing a warm body and carbon dioxide as a behavioral activator. J Am Mosq Control Assoc. 2010; 26:381-386.

The controlling effect, repellence & spatial repellence, may be determined by testing the Warm Body assay against the yellow fever mosquito, Aedes aegypti Rockefeller strain. A. aegypti is a model organism for controlling tests and one of the recommended model organisms by the World Health Organization (WHO) as it is a very aggressive, anthropophilic mosquito species that shows generally low sensitivity to arthropod controlling compounds. Observations of controlling efficacy are made on host-seeking females of uniform age, 5 to 10 days old selected as mentioned in the publication mentioned hereinabove. Tested hungry females have access to 10% sugar solution but were not blood-fed.

The controlling effect, repellence & spatial repellence may also be determined according to an arm in the box method adapted from the WHO Guidelines for efficacy testing of mosquito repellents for human skin (WHO/CDS/NTD/WHOPES/2009.4). The readiness of 100 hungry female mosquitoes A. aegypti to a test substance is thereby assessed by comparing the results of an untreated arm to a treated in when inserted into the cage (40×40×40 cm) for 30 seconds (negative control) three times.

The activity for substances to repel arachnids such as ticks may be assessed using the protocol of the in-vitro Warm Plate Assay as defined in Kröber T, Bourquin M, Guerin P M. 2013. A standardized in vivo and in vitro test method for evaluating tick repellents. Pestic. Biochem. Phys. 107(2):160-168.

In a particular embodiment, the composition of the invention comprises the compound in an amount effective to control arthropods.

In a particular embodiment, the composition comprises the compound in an amount of from 0.00032 to 30 wt. %, based on the total weight of the composition, preferably of from 0.001 to 10 wt. %, more preferably of from 0.5 to 5 wt. %.

In a particular embodiment, the composition comprises the compound in an amount of from 0.00032 to 20 wt. %, based on the total weight of the composition, preferably of from 0.001 to 10 wt. %.

In a particular embodiment, the composition comprises the compound in an amount of from 0.001 to 1 wt. %, based on the total weight of the composition.

In a particular embodiment, the composition comprises the compound in an amount of from 0.01 to 1 wt. %, based on the total weight of the composition, preferably of from 0.5 to 1 wt. %.

In a particular embodiment, the composition comprises the compound in an amount of at least 0.01 wt. %, based on the total weight of the composition.

In a particular embodiment, the composition comprises the compound in an amount of at least 0.04 wt. %, based on the total weight of the composition.

In a particular embodiment, the composition is liquid, preferably at room temperature (25° C.), and comprises the compound in an amount of from 0.001 mg/mL to 100 mg/mL, preferably from 0.001 mg/mL to 10 mg/mL, more preferably from 0.016 mg/mL to 10 mg/mL, yet more preferably from 0.08 mg/mL to 10 mg/mL, most preferably from 0.4 mg/mL to 10 mg/mL.

In a particular embodiment, the amount and selection of the substance is in a way that it contributes, enhances or improves both, the arthropod control activity and the hedonic character of the composition.

In a particular embodiment, the arthropod control composition may further comprise an arthropod control co-ingredient. By “arthropod control co-ingredient” is understood an ingredient capable of imparting additional arthropod controlling benefits to the arthropod controlling effect of the composition herein described.

In a particular embodiment, the compound described is capable to modify, enhance or improve the arthropod controlling effect of the arthropod control co-ingredient, e.g. by reducing the amount of the arthropod control co-ingredient within a composition. This can be particularly beneficial in case the arthropod control co-ingredient is harmful to human subjects at a certain dose or in case the arthropod control co-ingredient has negative olfactive properties at a certain dose.

According to a particular embodiment, the combination of the compound herein described and arthropod control co-ingredient results in a synergistic arthropod controlling effect.

According to a particular embodiment, the combination of substance herein described and arthropod control co-ingredient results in a modified, pleasant, enhanced or improved olfactory impression of the overall composition in comparison to its single ingredients.

According to a particular embodiment, the arthropod control co-ingredient is selected from the group consisting of: N,N-diethyl-3-methylbenzamide (DEET), ethyl butylacetylaminopropionate (IR3535); para-menthan-3,8-diol (PMD); 1-(1-methylpropoxycarbonyl)-2-(2-hydroxaethyl)piperidin (picaridin); Cedarwood oil China, Cedarwood oil Texas, Cedarwood oil Virginia, Cinnamon oil, Citronella oil, Cornmint oil, Cymbopogon winterianus oil fractionated hydrated cyclized, decanoic acid, Eucalyptus citriodora oil, Eucalyptus citriodora oil hydrated cyclized, eugenol, Garlic oil, geraniol, Geranium oil, Lavender oil, Lavandula hybrida oil, Lavandin oil, Lemon oil, Lemongrass oil, Margosa extract, Metofluthrin, mixture of cis- and trans-p-menthane-3,8 diol, N,N-diethyl-meta-toluamide, nonanoic acid, Rosemary oil, Thyme oil, Wintergreen oil, 2,3,4,5-bis(butyl-2-ene)tetrahydrofurfural (MGK Repellent 11), cineole, cinnamaldehyde, citronellal, citronellol, coumarin, dibutyl phthalate, diethyl phthalate, dimethyl anthranilate, dimethyl phthalate, ethyl vanillin, Eucalyptus oil, hydroxy citronellal, Lime oil, limonene, linalool, methyl anthranilate, Mint oil, myrcene, Neem oil, sabinene, β-caryophyllene, (1H-indol-2-yl)acetic acid, anethole, Anise oil, Basil oil, Bay oil, camphor, ethyl salicylate, Evergreen oils (pine oil), Clove oil, nootkatone, 2-undecanone, sulcatone, (1,3,4,5,6,7-hexahydro-1,3-dioxo-2H-isoindol-2-yl)methyl 2,2-dimethyl-3-(2-methylprop-1-enyl)cyclopropanecarboxylate (d-Tetramethrin), 3-Allyl-2-methyl-4-oxocyclopent-2-enyl-2,2-dimethyl-3-(2-methylprop-1-enyl)-cyclopropanecarboxy late (d-Allethrin), α-cyano-3-phenoxybenzyl, 3-(2,2-dichlorovinyl)-2,2-dimethylcyclopropanecarboxylate (Cypermethrin), 2-methyl-4-oxo-3-(prop-2-ynyl)cyclopent-2-en-1-yl 2,2-dimethyl-3-(2-methylprop-1-enyl)cyclopropanecarboxylate (Prallethrin), Acetamiprid, Azadirachtin, Bendiocarb, Bifenthrin, boric acid, Chlorpyrifos, Deltamethrin, Diazinon, Dichlorvos, eugenol, Fipronil, Imidacloprid, Malathion, Maltodextrin, Metofluthrin, Nicotine, Permethrin, Pyrethrins, Pyrethroids, Rotenone, silicium dioxide (Kieselguhr), S-Methoprene, Spinosad (Spinosyn A), Spinosyn D, Tetramethrin, Transfluthrin, 1-(2,6,6-trimethylcyclohex-2-en-1-yl)but-2-en-1-one, 3-butylidene-2-benzofuran-1-one, 4-ethenyl-2-methoxyphenol, Cognac oil green, Labdanum extract (Cistus spp.), 5-pentyloxolan-2-one, chromen-2-one, 3,7-dimethylocta-2,6-dienal, 4-hydroxy-3-methoxybenzaldehyde, 2-methyl-5-prop-1-en-2-ylcyclohex-2-en-1-one, Mentha spicata oil, 6-hexyloxan-2-one, 5-methyl-2-propan-2-ylcyclohexyl]acetate, Nigella damascena oil, 2-phenylethanol, 6-pentyloxan-2-one, (4-methoxyphenyl)methyl acetate, Syzygium aromaticum oil, 3,4,4a,5,6,7,8,8a-octahydrochromen-2-one, 3,7,7-trimethylbicyclo[4.1.0]hept-3-ene, 2-phenylethyl 2-methylpropanoate, methyl 2-(3-oxo-2-pent-2-enylcyclopentyl)acetate, 4-(2-methoxypropan-2-yl)-1-methylcyclohexene, Mentha piperita oil, 2-methoxy-4-[prop-1-enyl]phenol, 2-methyl-3-(4-propan-2-ylphenyl)propanal, (4-methoxyphenyl)methanol, 2,3-dihydro-1H-indene-2-carbonitrile, 2,4-dimethyl-4,4a,5,9b-tetrahydroindeno[1,2-d][1,3]dioxine, 2,4-dimethyl-4,4a,5,9btetrahydroindeno[1,2-d][1,3]dioxine, (2,5-dimethyl-2,3-dihydro-1H-inden-2yl)methanol, (4aRS,9bRS)-4a,7-dimethyl-4,4a,5,9b-tetrahydroindeno[1,2-d][1,3]dioxine, (2RS,4aRS,9bRS)-2,4a,7-trimethyl-4,4a,5,9b-tetrahydroindeno[1,2-d][1,3]dioxine (2RS,4aSR,9bSR)-2,4a,7-trimethyl-4,4a,5,9b-tetrahydroindeno[1,2-d][1,3]dioxine, (2-methyl-1,3-dihydroinden-2-yl)methanol, 2,3-dihydro-1H-inden-2-ylmethanol, (2RS,4RS,4ASR,9BRS)-2,4-dimethyl-4,4a,5,9b-tetrahydroindeno[1,2-d][1,3]dioxine, (2RS,4aRS,9bSR)-2-methyl-4,4a,5,9b-tetrahydroindeno[1,2-d][1,3]dioxin (2RS,4aSR,9bRS)-2-methyl-4,4a,5,9b-tetrahydroindeno[1,2-d][1,3]dioxin, (4aRS,9bSR)-2,2-dimethyl-4,4a,5,9b-tetrahydroindeno[1,2-d][1,3]dioxin, (2,4,6-trimethyl-2,3-dihydro-1H-inden-2-yl)methanol, 5-(tert-butyl)-1,3-dihydrospiro[indene-2,3′-oxetane], (2RS,4RS,4ARS,9BSR)-2,4-dimethyl-4,4a,5,9b-tetrahydroindeno[1,2-d][1,3]dioxine, 4A,8-dimethyl-indano[1,2-d]-1,3-dioxan-2-one, 1-(2,5-dimethyl-2,3-dihydro-1H-inden-2-yl)ethanone, (5-methyl-2,3-dihydro-1H-inden-2-yl)methanol, (4aRS,9bSR)-8-methyl-4,4a,5,9b-tetrahydroindeno[1,2-d][1,3]dioxin, (2RS,4aRS,9bSR)-2-ethyl-4,4a,5,9b-tetrahydroindeno[1,2-d][1,3]dioxine (2RS,4aSR,9bRS)-2-ethyl-4,4a,5,9b-tetrahydroindeno[1,2-d][1,3]dioxine, (2R,4aS,9bS)-2,4a,8-trimethyl-4,4a,5,9b-tetrahydroindeno[1,2-d][1,3]dioxin, 1-(2,5-dimethyl-2-indanyl)-1-ethanol, (2,5-dimethyl-2,3-dihydro-1H-inden-2yl)methanol, (2RS,4aRS,9bSR)-2,8-dimethyl-4,4a,5,9b-tetrahydroindeno[1,2-d][1,3]dioxine (2RS,4aSR,9bRS)-2,8-dimethyl-4,4a,5,9b-tetrahydroindeno[1,2-d][1,3]dioxine, (2RS,4aSR,9bSR)-2,4a-dimethyl-4,4a,5,9b-tetrahydroindeno[1,2-d][1,3]dioxin, (4aRS,9bRS)-4a,8-dimethyl-4,4a,5,9b-tetrahydroindeno[1,2-d][1,3]dioxin, 1-(2,4,5-trimethyl-2,3-dihydro-1H-inden-2-yl)ethenone, (2RS,4aRS,9bSR)-2-ethyl-8-methyl-4,4a,5,9b-tetrahydroindeno[1,2-d][1,3]dioxin, (2RS,4aSR,9bRS)-2-ethyl-8-methyl-4,4a,5,9b-tetrahydroindeno[1,2-d][1,3]dioxin, (4aRS,9bRS)-2,2,4a,8-tetramethyl-4,4a,5,9b-tetrahydroindeno[1,2-d][1,3]dioxine, 5-tert-butyl-indan-2-spiro-3′-oxetane, (2,6-dimethyl-1,2,3,4-tetrahydro-2-naphthalenyl)methanol, (4aRS,9bRS)-2,2,4atrimethyl-4,4a,5,9b-tetrahydroindeno[1,2-d][1,3]dioxine, (4aRS,9bRS)-2,2,4a,7-tetramethyl-4,4a,5,9b-tetrahydroindeno[1,2-d][1,3]dioxine, 3-(3/4-ethylcyclopent-1-en-1-yl)-2-methylpropanal, 3-(3/4-propylcyclopent-1-en-1-yl)-2-methylpropanal, 3-(3/4-butylcyclopent-1-en-1-yl)-2-methylpropanal, 3-(3/4-isopropylcyclopent-1-en-1-yl)-2-methylpropanal, 3-(3/4-(sec-butyl)cyclopent-1-en-1-yl)-2-methylpropanal, 3-(3/4-(tert-butyl)cyclopent-1-en-1-yl)-2-methylpropanal, 3-[4-(2-methoxy-2-propanyl)-2-methylphenyl]propanal, 3-[4-(2-hydroxy-2-methylpropyl)phenyl]propanal, 3-(4-tert-butyl-2-methylphenyl)propanal, 3-(4-tert-butylphenyl)propanal, 3-(3-propan-2-ylphenyl)butanal, 3-(4-methoxyphenyl)-2-methylpropanal, 2,6-dimethoxy-4-[prop-1-enyl]phenol, 4-allyl-2,6-dimethoxyphenol, 1,2,3-trimethoxy-5-[1-propen-1-yl]benzene, 1,2,3-trimethoxy-5-propylbenzene, 1,2,4-trimethoxybenzene, 2,6-dimethoxy-4-propylphenol, 2,6-dimethoxy-4-methylphenol, 3-(3,4,5-trimethoxyphenyl)prop-2-enoic acid, 2-(4-hydroxy-3-methoxyphenyl)acetic acid, methyl 3-(3,4-dimethoxyphenyl)-2-methylpropanoate, (2,3-dimethoxyphenyl)methanol, 2,3,4-trimethoxybenzaldehyde, 3,4,5-trimethoxybenzaldehyde, 2-ethoxy-4-(methoxymethyl)phenol, 2-ethoxy-4-(ethoxymethyl)phenol, 1,2-dimethoxy-4-prop-1-enylbenzene, 1,2,3-trimethoxy-5-methylbenzene, 2,6-dimethoxy-4-methylphenol, 1-(2,3,4-trimethoxyphenyl)ethanone, 7-methyl-1,5-benzodioxepin-3-one, 1,2-dimethoxy-3-prop-1-enylbenzene, 1,2,3-trimethoxy-5-propylbenzene, 2,3,4-trimethoxybenzonitrile, 3-ethoxy-4-methoxybenzaldehyde, 2,3,4-trimethoxyphenol, 1-(4-hydroxy-3-methoxyphenyl)ethanone, 2-methoxy-4-(4-methylideneoxan-2-yl)phenol, 4-(3,6-dihydro-4-methyl-2H-pyran-2-yl)-2-methoxy-phenol, 3-(4-isopropyl-2-methylphenyl)propanal, 3-(2-isopropyl-4-methylphenyl)propanal and mixtures thereof.

In a particular embodiment, the arthropod control co-ingredient is comprised in the composition in an amount of from 0.02 to 80 wt. %, more preferably in an amount of from 0.05 to 70 wt. %, even more preferably in an amount of from 0.1 to 60 wt. %, based on the total weight of the composition. Thereby, it is understood that the composition comprises the arthropod control co-ingredient in a minimum amount of at least 0.02 wt. %, at least 0.05 wt. % or at least 0.1 wt. % and a maximum amount of not more than 80 wt. %, not more than 70 wt. % or not more than 60 wt. %, based on the total weight of the composition.

In a particular embodiment, the compound in the composition of the invention and the arthropod control co-ingredient are comprised in the composition in a weight range of 90:10 to 10:90, preferably in a weight range of 80:20 to 20:80, more preferably in a weight range of 65:35 to 35:65 and most preferably in a weight range of 60:40 to 40:60. It is herein also understood that the compound and the arthropod control co-ingredient can be comprised in the composition in any weight range combination as mentioned herein-before, such as 90:10 to 20:80, preferably 35:65 and more preferably 40:60, 80:20 to 10:90, preferably 35:65 and more preferably 40:60, 65:35 to 10:90, preferably 20:80 and more preferably 40:60 or 40:60 to 10:90, preferably 20:80 and more preferably 35:65.

In one embodiment, the arthropod control composition may further comprise perfume ingredients. Perfume ingredients are understood as contributing, modifying, enhancing or improving the olfactory character of the composition but do not contribute to, enhance or improve the arthropod controlling effect of the composition. Perfume ingredients providing such hedonic effects and suitable for use in the composition of the invention are known in the art and can be readily identified by the skilled person.

The arthropod control composition can further comprise a carrier. By “carrier” is understood a material with which the active compound is mixed or formulated to facilitate its application a locus or other object to be treated, or its storage, transport and/or handling. Said carrier may be of inorganic or organic or of synthetic natural origin. Said carrier may be a liquid or a solid.

As liquid carrier one may cite, as non-limiting examples, an emulsifying system, i.e. a solvent and a surfactant system, or a solvent commonly used in perfumery. A detailed description of the nature and type of solvents commonly cannot be exhaustive. However, one can cite as non-limiting examples, solvents such as butylene or propylene glycol, glycerol, dipropylene glycol and its monoether, 1,2,3-propanetriyl triacetate, dimethyl glutarate, dimethyl adipate 1,3-diacetyloxypropan-2-yl acetate, diethyl phthalate, isopropyl myristate, benzyl benzoate, benzyl alcohol, 2-(2-ethoxyethoxy)-1-ethanol, tri-ethyl citrate, 2-methylprop-1-ene and 2-(2-ethoxyethoxy)ethanol or mixtures thereof, particular suitable are dipropylene glycol, 2-methylprop-1-ene and 2-(2-ethoxyethoxy)ethanol and mixtures thereof.

For the compositions which comprise both a carrier, other suitable carriers than those previously specified, can be also ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company) like Dowanol™ DPMA (Glycol Ether Acetate), or Augeo® Clean Multi (isopropylidene glycerol; origin: Solvay), or hydrogenated castors oils such as those known under the trademark Cremophor® RH 40 (origin: BASF).

In a particular embodiment, the composition further comprises ethanol. Preferably, the composition comprises ethanol in an amount of from 80 to 99.9 wt. %, based on the total amount of the composition.

Solid carrier is meant to designate a material to which the arthropod control composition or some element of the arthropod control composition can be chemically or physically bound. In general, such solid carriers are employed either to stabilize the composition, or to control the rate of evaporation of the compositions or of some ingredients. The use of solid carrier is of current use in the art and a person skilled in the art knows how to reach the desired effect. However, by way of non-limiting example of solid carriers, one may cite absorbing gums or polymers or inorganic material, such as porous polymers, cyclodextrins, wood based materials, organic or inorganic gels, clays, gypsum talc or zeolites.

As other non-limiting examples of solid carriers, one may cite encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or other such materials. The encapsulation is a well-known process to a person skilled in the art, and may be performed, for instance, by using techniques such as spray-drying, agglomeration or yet extrusion; or consists of a coating encapsulation, including coacervation and complex coacervation technique.

As non-limiting examples of solid carriers, one may cite in particular the core-shell capsules with resins of aminoplast, polyamide, polyester, polyurea or polyurethane type or a mixture thereof (all of said resins are well known to a person skilled in the art) using techniques like phase separation process induced by polymerization, interfacial polymerization, coacervation or altogether (all of said techniques have been described in the prior art), optionally in the presence of a polymeric stabilizer or of a cationic copolymer.

Resins may be produced by the polycondensation of an aldehyde (e.g. formaldehyde, 2,2-dimethoxyethanal, glyoxal, glyoxylic acid or glycolaldehyde and mixtures thereof) with an amine such as urea, benzoguanamine, glycoluryl, melamine, methylol melamine, methylated methylol melamine, guanazole and the like, as well as mixtures thereof. Alternatively, one may use preformed resins alkylolated polyamines such as those commercially available under the trademark Urac® (origin: Cytec Technology Corp.), Cymel® (origin: Cytec Technology Corp.), Urecoll® or Luracoll® (origin: BASF).

Others resins one are the ones produced by the polycondensation of an a polyol, like glycerol, and a polyisocyanate, like a trimer of hexamethylene diisocyanate, a trimer of isophorone diisocyanate or xylylene diisocyanate or a Biuret of hexamethylene diisocyanate or a trimer of xylylene diisocyanate with trimethylolpropane (known with the tradename of Takenate®, origin: Mitsui Chemicals), among which a trimer of xylylene diisocyanate with trimethylolpropane and a Biuret of hexamethylene diisocyanate.

In a particular embodiment, the composition does not comprise acetyl cedrane.

In a particular embodiment, the composition does not comprise (9E)-9-Ethylidene-3-oxatricyclo[6.2.1.0^{2,7}]undecan-4-one.

In a particular embodiment, the composition does not comprise nepetalactone.

The present invention also relates to a method for arthropod, preferably insect, control which comprises bringing an arthropod, preferably insect, into direct contact or in contact with vapors of a composition according to the invention.

For the sake of clarity, the arthropod controlling composition according to the present invention can be applied to the air, to the surface of an article, the air in the vicinity of the surface of an article or the surface of a subject by usual methods known in the art such as spraying, applying, wearing or diffusing.

In a particular embodiment, the arthropod controlling composition according to the present invention is applied to the surface of an article, the air in the vicinity of the surface of an article or to the surface of an animal or subject.

In a particular embodiment, the article can be an arthropod control article as described hereinbelow and in particular, can be a candle, coil, electric diffuser, wristband, patch, collar, ear tag, clothes, fabrics, papers, biochar, cardboard, cellulosic pads, bed nets, screen, curtains, furniture, paint, walls, ground, spray, aerosol, cream, roll on, wristband, lotion, soap, shampoo, sunscreen, laundry powder, liquid detergent, spray, lotion, powder.

In a particular embodiment, the surface of a subject is the surface of a human or animal subject, preferably the surface is a human subject, i.e. the skin of a human subject.

The present invention also relates to a use of a composition according to the invention to control arthropods, preferably insects.

The present invention also relates to a consumer product comprising the composition according to the invention.

Non-limiting examples of suitable consumer products include a perfume, such as a fine perfume, a splash or eau de parfum, a cologne or a shave or after-shave lotion or a cream or gel; a fabric care product, such as a liquid or solid detergent, a laundry powder, a fabric softener, a liquid or solid scent booster, a fabric refresher, an ironing water, a paper, a bleach, a carpet cleaner, a curtain-care product; a body-care product, such as a hair care product (e.g. a shampoo, a coloring preparation or a hair spray, a color-care product, a hair shaping product), a dental care product, a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); or a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc.); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner; a candle; a spray, a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint, more preferably a candle, a spray, a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint.

In a preferred embodiment of the invention, the consumer product is an electric diffuser. In this embodiment of the invention, the substance in the arthropod, preferably insect, control composition is present at certain quantities.

The invention will be described in further detail by way of the following non-limiting examples.

### Examples

### 1. Experimental Protocols and Methods Used

### 1.1 Warm Body Assay is the Small-Scale Test Used to Screen the Repellent Efficacy on Mosquitoes at 3-15 Concentrations at T0.

Aedes aegypti is a model organism for controlling tests and one of the recommended model organisms by the World Health Organization (WHO) as it is a very aggressive anthropophilic mosquito species that shows generally low sensitivity to arthropod controlling compounds. Anopheles gambiae is also a model organism as it is anthropophilic and transmits malaria.

The controlling effect according to the present invention was assessed using an adapted Warm Body assay as defined in Kröber T, Kessler S, Frei J, Bourquin M, Guerin P M. 2010. J Am Mosq Control Assoc. 26:381-386. In this in-vitro assay the number of mosquito landing on a warm body, simulating an attractive host treated with the tested stimuli, was measured in order to assess the repellence effect.

The published protocol has been adapted as the switch from Anopheles gambiae to Ae. aegypti led to a decrease of mosquitoes placed in the tested cage due to the size difference (i.e. 30 mosquitoes instead of 50) and to an increase of lighting since Ae. aegypti is a diurnal mosquitoes (i.e. 150 lux instead of 4 lux).

On the sandblasted glass Petri dish covering the warm body (28.3 cm²), 100 μL of the compounds diluted at different concentrations in ethanol was applied. The number of mosquito landing on the warm body was counted for each stimulus. Number of landings on pure ethanol (solvent) control treatment was used to normalize the data and calculate the percentage of repellence.

### 1.2 Arm-In-Cage Test is the Large-Scale Test Used to Assess on Human Volunteer the Repellent Efficacy on Mosquitoes Over Time:

The Arm in the box method was adapted from the WHO Guidelines for efficacy testing of mosquito repellents for human skin (WHO/CDS/NTD/WHOPES/2009.4) and/or based on EU biocide testing guidelines (Guidance on the Biocidal Products Regulation. Vol. II Efficacy—Assessment and Evaluation (Parts B+C), v. 4.0. December 2021). The readiness of 200 hungry female mosquitoes Ae. aegypti or 50 An. gambiae to probe is assessed by inserting the untreated arm of human volunteers into the cage (40×40×40 cm) for 30 seconds (negative control) in order to determine probing activity. Then, the product is applied onto the skin of the forearm of the human volunteer (1 mL per 600 cm²) and after 5 minutes (Ae. aegypti) or 30 minutes (An. gambiae), this arm is inserted into the cage and exposed for 3 minutes. The assay take place in temperature (27±2° C.) and humidity (80±10% RH) regulated room on three different human volunteers.

### 1.3 Warm Plate Assay is the Small-Scale Test Used to Screen the Repellent Efficacy on Ticks at Different Concentrations at T0.

Repellent efficacy of the different compounds was assessed against the castor bean tick, Ixodes ricinus L that can transmit both bacterial and viral pathogens. I. ricinus is one of the recommended model organisms mentioned by the Guidance on the European Biological Products Regulation (Vol II, Efficacy—Assessment & Evaluation (Parts B+C), v. 3.0, April 2018). Observations of repellent efficacy were made on last stage nymphs.

The repellent efficacy was assessed using the protocol of the in-vitro Warm Plate Assay as defined in Kröber T, Bourquin M, Guerin P M. 2013. A standardized in vivo and in vitro test method for evaluating tick repellents. Pestic. Biochem. Phys. 107(2):160-168.

### 2. Results of Deterrence and Spatial Repellence Effect on Arthropods

### 2.1 Results of Warm Body Assay for Mosquito: Small Scale Assay to Assess Deterrence and Spatial Repellence

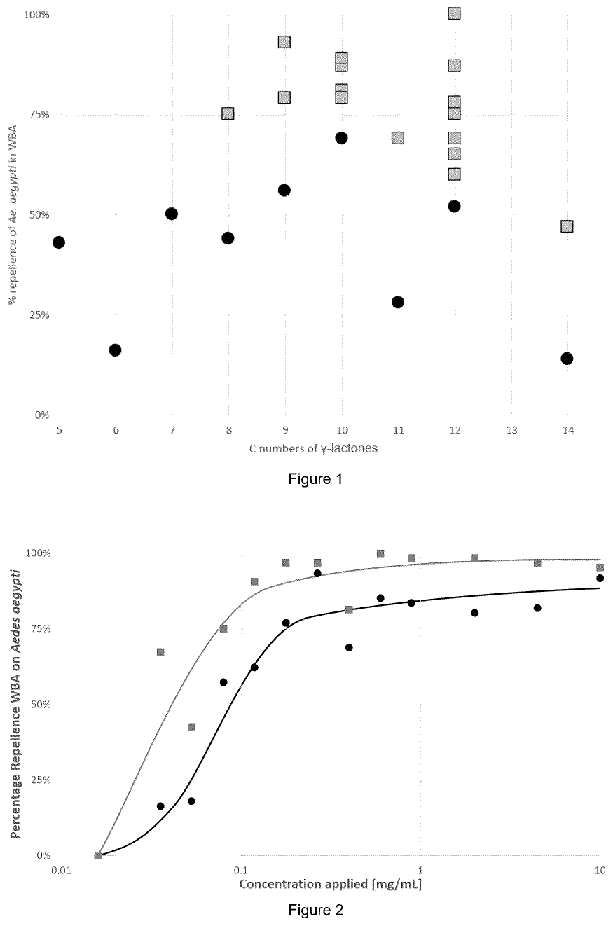

As displayed in Table 1 below and FIG. 1, saturated γ-lactones with a short hydrocarbon chain (<7 carbons) or a long carbonyl chain (>10 carbons) demonstrated a lower efficacy in repelling Ae. aegypti mosquitoes than γ-lactones containing 7 to 10 carbons.

In Table 1, the results of three concentrations per stimulus are shown. The R chain corresponds to the carbon chain attached to the oxolan-2-one in position 5. The mean number of mosquito landings with the solvent only (0 mg/mL) is equal to 66.7±7.7 landings in two minutes.

TABLE 1
Percentage of repellence of mosquitoes Aedes aegypti
landing on the warm body baited with different γ-
lactones at different concentrations.

| | Carbon | R | 0.016 | 0.4 | 10 |
|---|---|---|---|---|---|
| | number | chain | mg/mL | mg/mL | mg/mL |
| 5-methyloxolan- | 5 | saturated | 0% | 43% | 2% |
| 2-one | | | | | |
| 5-ethyloxolan- | 6 | saturated | 0% | 16% | 74% |
| 2-one | | | | | |
| 5-propyloxolan- | 7 | saturated | 28% | 50% | 100% |
| 2-one | | | | | |
| 5-butyloxolan- | 8 | saturated | 41% | 44% | 100% |
| 2-one | | | | | |
| 5-but-3- | 8 | unsaturated | 57% | 75% | 100% |
| enyloxolan-2- | | | | | |
| one | | | | | |
| 5-pentyloxolan- | 9 | saturated | 9% | 56% | 99% |
| 2-one | | | | | |
| 5-pent-3- | 9 | unsaturated | 0% | 95% | 100% |
| enyloxolan-2- | | | | | |
| one | | | | | |
| 5-pent-1- | 9 | unsaturated | 52% | 79% | 100% |
| enyloxolan-2- | | | | | |
| one | | | | | |
| 5-hexyloxolan- | 10 | saturated | 0% | 69% | 92% |
| 2-one | | | | | |
| 5-hex-1- | 10 | unsaturated | 46% | 87% | 95% |
| enyloxolan-2- | | | | | |
| one | | | | | |
| 5-hex-3- | 10 | unsaturated | 0% | 81% | 95% |
| enyloxolan-2- | | | | | |
| one | | | | | |
| 5-hex-3-enyl-5- | 10 | unsaturated | 39% | 79% | 96% |
| methyloxolan- | | | | | |
| 2-one | | | | | |
| 5-hex-5- | 10 | unsaturated | 14% | 89% | 100% |
| enyloxolan-2- | | | | | |
| one | | | | | |
| 5-heptyloxolan- | 11 | saturated | 15% | 28% | 70% |
| 2-one | | | | | |
| 5-octyloxolan- | 12 | saturated | 12% | 52% | 45% |
| 2-one | | | | | |
| 5-oct-1- | 12 | unsaturated | 0% | 60% | 98% |
| enyloxolan-2- | | | | | |
| one | | | | | |
| 5-oct-2- | 12 | unsaturated | 85% | 100% | 96% |
| enyloxolan-2- | | | | | |
| one | | | | | |
| 5-oct-3- | 12 | unsaturated | 31% | 76% | 92% |
| enyloxolan-2- | | | | | |
| one | | | | | |
| 5-[(E)-oct-5- | 12 | unsaturated | 0% | 87% | 100% |
| enyl]oxolan-2- | | | | | |
| one | | | | | |
| 5-[(Z)-oct-5- | 12 | unsaturated | 0% | 75% | 100% |
| enyl]oxolan-2- | | | | | |
| one | | | | | |
| 5-oct-6- | 12 | unsaturated | 12% | 78% | 100% |
| enyloxolan-2- | | | | | |
| one | | | | | |
| 5-oct-7- | 12 | unsaturated | 46% | 69% | 80% |
| enyloxolan-2- | | | | | |
| one | | | | | |
| 5-[(1E,5Z)-octa- | 12 | unsaturated | 52% | 65% | 97% |
| 1,5- | | | | | |
| dienyl]oxolan- | | | | | |
| 2-one | | | | | |
| 5-decyloxolan- | 14 | saturated | 2% | 14% | 60% |
| 2-one | | | | | |
| 5-dec-7- | 14 | unsaturated | 17% | 47% | 85% |
| enyloxolan-2- | | | | | |
| one | | | | | |

Table 1 shows that the tested unsaturated γ-lactones were more efficient than their saturated counterparts, i.e. with the same carbon chain length, the presence of an unsaturation conferred a higher repellent potency to the compounds. This can also be observed from FIG. 1, wherein the data of Table in relation to the second concentration (0.4 mg/mL) are again shown.

The observations made in Table 1 and FIG. 1, respectively, were confirmed by the precise measures of Ae. aegypti repellence by the C₁₀ γ-lactones over 13 different concentrations (see FIG. 2). Indeed, the repellence efficacy of the unsaturated C₁₀ γ-lactone, 5-hex-3-enyloxolan-2-one is significantly higher than the one of the saturated C₁₀ γ-lactones, 5-hexyloxolan-2-one (paired t-test, p=0.026; see FIG. 2).

Similarly, both C₁₀ unsaturated γ-lactones showed a relevant dose-response repellent effect towards An. gambiae, demonstrating the clear biological effect of the stimuli on the mosquito (see Table 2). Eight concentrations were assessed on each stimulus. The mean number of mosquito landings with the solvent only (0 mg/mL) is equal to 50.0±4.7 landings in two minutes. As soon as a concentration of one of these unsaturated γ-lactones is >0.09%, no Anopheles mosquito dares to land on the attractive warm body, demonstrating a potent repellent effect (see Table 2).

TABLE 2
Percentage of repellence of mosquitoes Anopheles gambiae landing on the
warm body baited with unsaturated γ-lactones at different concentrations.

| | 0.08 | 0.178 | 0.267 | 0.598 | 0.89 | 2 | 4.47 | 10 |
|---|---|---|---|---|---|---|---|---|
| | mg/mL | mg/mL | mg/mL | mg/mL | mg/mL | mg/mL | mg/mL | mg/mL |
| 5-hex- | 12% | 38% | 95% | 93% | 100% | 100% | 100% | 100% |
| 3-enyloxolan- | | | | | | | | |
| 2-one | | | | | | | | |
| 5-hex- | 65% | 72% | 73% | 88% | 98% | 100% | 100% | 100% |
| 5-enyloxolan- | | | | | | | | |
| 2-one | | | | | | | | |

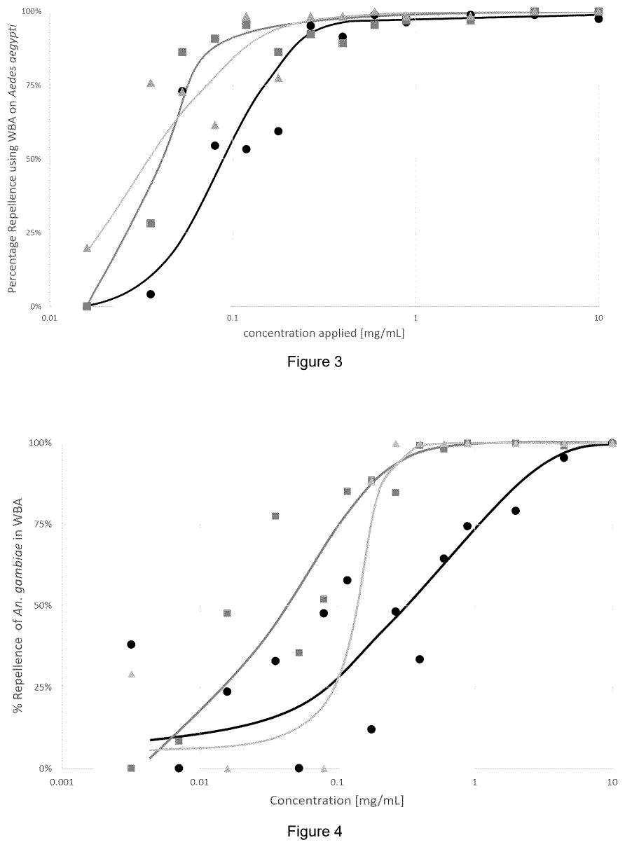

Similar to the γ-lactones, the unsaturated δ-lactones were also found to be more efficient to repel Ae. aegypti mosquitoes than their saturated counterparts; lower doses of unsaturated δ-lactones are sufficient to reach similar efficacy (see Table 3). In particular, the unsaturated C₁₀ δ-lactones 6-pent-2-enyloxan-2-one and 6-pent-3-enyloxan-2-one were significantly more efficient to repel the mosquitoes than saturated C₁₀ δ-lactone 6-pentyloxan-2-one (paired t-test, p=0.01 and p=0.04 respectively; see Table 3 and FIG. 3). With C₇ 6-lactones, the unsaturated 6-ethenyloxan-2-one prevents any mosquito from landing when applied at a concentration of 10 mg/mL (1 mg absolute is applied), whereas >50% still land when the same quantity of its saturated counterpart, 6-ethyloxan-2-one, was applied (see Table 3). For unsaturated C₁₁ δ-lactones protection was higher at both 0.4 mg/mL and 10 mg/mL concentration as compared to saturated C₁₁ δ-lactones (see Table 3).

TABLE 3
Percentage of repellence of mosquitoes Aedes aegypti
landing on the warm body baited with different
δ-lactones at different concentrations.

| | Carbon | R | 0.016 | 0.4 | 10 |
|---|---|---|---|---|---|
| | number | chain | mg/mL | mg/mL | mg/mL |
| 6-ethyloxan-2-one | 7 | saturated | 0% | 11% | 48% |
| 6-ethenyloxan-2-one | 7 | unsaturated | 31% | 30% | 100% |
| 6-pentyloxan-2-one | 10 | saturated | 0% | 91% | 98% |
| (6S)-6-pent-2-enyloxan- | 10 | unsaturated | 73% | 96% | 96% |
| 2-one | | | | | |
| (6R)-6-pent-2- | 10 | unsaturated | 78% | 100% | 98% |
| enyloxan-2-one | | | | | |
| 6-pent-3-enyloxan-2- | 10 | unsaturated | 20% | 98% | 100% |
| one | | | | | |
| 6-hexyloxan-2-one | 11 | saturated | 0% | 76% | 91% |
| 6-hex-3-ynyloxan-2-one | 11 | unsaturated | 0% | 80% | 97% |

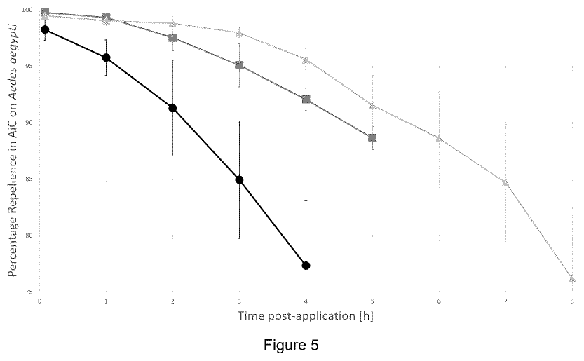

Similar results were obtained with An. gambiae; as with the γ-lactones, the unsaturated δ-lactones were more efficient to repel these mosquitoes than their saturated counterpart. As proof of concept, the unsaturated C₁₀ δ-lactones 6-pent-2-enyloxan-2-one and 6-pent-3-enyloxan-2-one were significantly more efficient to repel the mosquitoes than the saturated C₁₀ δ-lactone 6-pentyloxan-2-one (paired t-est, p=0.001 and p=0.007 respectively; see FIG. 4). Indeed, as with Ae. aegypti, lower doses are needed to reach similar efficacy.

Additionally, three β-lactones and five ε-lactones were also screened for their repellent effect against Ae. aegypti (see Table 4).

TABLE 4
Percentage of repellence of mosquitoes Aedes aegypti
landing on the warm body baited with different
β- and ε-lactones at different concentrations.

| | Lactone | R | 0.016 | 0.4 | 10 |
|---|---|---|---|---|---|
| | type | chain | mg/mL | mg/mL | mg/mL |
| 3,3-dimethyl-4- | β | saturated | 36% | 38% | 100% |
| propan-2- | | | | | |
| yloxetan-2-one | | | | | |
| (E)-3-buta-1,3- | β | unsaturated | 71% | 82% | 100% |
| dienyl-4- | | | | | |
| pentyloxetan-2- | | | | | |
| one | | | | | |
| (Z)-3-buta-1,3- | β | unsaturated | 64% | 87% | 95% |
| dienyl-4- | | | | | |
| pentyloxetan-2- | | | | | |
| one | | | | | |
| 7-tert- | ε | saturated | 0% | 0% | 66% |
| butyloxepan-2- | | | | | |
| one | | | | | |
| 7-but-3- | ε | unsaturated | 43% | 75% | 99% |
| enyloxepan-2-one | | | | | |
| 7-pentyloxepan-2- | ε | saturated | n.d. | 52% | 98% |
| one | | | | | |
| 7-pent-4- | ε | unsaturated | n.d. | 95% | 100% |
| enyloxepan-2-one | | | | | |
| 7- | ε | saturated | 0% | 10% | 26% |
| cyclohexyloxepan- | | | | | |
| 2-one | | | | | |

n.d. is indicated if no data available.

As with b- and γ-lactones, unsaturated β- and ε-lactones provided a quicker repellent effect compared to saturated β- and ε-lactones (see Table 4). For example, the 3-lactone 3-buta-1,3-dienyl-4-pentyloxetan-2-one already repelled >80% of mosquitoes with a concentration of 0.4 mg/mL, while at this same concentration, 3,3-dimethyl-4-propan-2-yloxetan-2-one repels <40% (see Table 4). Similarly, unsaturated-lactones provided better repellency as highlighted by the results at 0.4 mg/mL of the C₁₁ δ-lactones; the unsaturated 7-pent-4-enyloxepan-2-one already reached 95% repellence whereas its saturated counterpart 7-pentyloxepan-2-one only reached 52% (see Table 4).

More complex lactones were additionally also screened for their repellent effect against Ae. aegypti (see Table 5). All of them demonstrated >50% of repellence at a concentration of 0.4 mg/mL (see Table 5).

TABLE 5
Percentage of repellence of mosquitoes Aedes aegypti landing on the
warm body baited at three concentrations with lactones containing an
unsaturation in the lactone ring (A), lactones with two hydrocarbon
groups on the lactone ring (B), and lactones with R1 and R2
taken together forming a cycloalkyl-, cycloalkenyl-, or arylring that
may be substituted with one or more methyl or ethyl groups (C).

| | compound | R | 0.016 | 0.4 | 10 |
|---|---|---|---|---|---|
| | type | chain | mg/mL | mg/mL | mg/mL |
| 2-pentyl-2H-furan-5- | A | saturated | 0% | 53% | 100% |
| one | | | | | |
| 5-pentyl-3,4-dihydro- | A | saturated | 60% | 69% | 97% |
| 2H-pyran-2-one | | | | | |
| 5-hexyl-3,4-dihydro- | A | saturated | 11% | 75% | 98% |
| 2H-pyran-2-one | | | | | |
| 5-heptyl-3,4-dihydro- | A | saturated | 0% | 95% | 100% |
| 2H-pyran-2-one | | | | | |
| 4-methyl-5- | B | saturated | 36% | 72% | 100% |
| pentyloxolan-2-one | | | | | |
| 5-hexyl-5- | B | saturated | 43% | 75% | 97% |
| methyloxolan-2-one | | | | | |
| 1-oxaspiro[4.5]decan- | B | saturated | 54% | 79% | 100% |
| 2-one | | | | | |
| 3,4,4a,5,6,7,8,8a- | C | saturated | 35% | 90% | 100% |
| octahydrochromen-2- | | | | | |
| one | | | | | |
| 3,6-dimethyl- | C | saturated | 0% | 90% | 98% |
| 3a,4,5,6,7,7a- | | | | | |
| hexahydro-3H-1- | | | | | |
| benzofuran-2-one | | | | | |
| 3-propylidene-2- | C | unsaturated | 83% | 93% | 86% |
| benzofuran-1-one | | | | | |
| 4,4,7a-trimethyl-3a,5- | C | unsaturated | 83% | 92% | 100% |
| dihydro-3H-1- | | | | | |
| benzofuran-2-one | | | | | |

Blending unsaturated lactones together or with other compounds also allowed to elicit relevant repellence against Ae. aegypti (see Table 6).

TABLE 6
Percentage of repellence of mosquitoes Aedes aegypti landing on the
warm body baited at different concentrations with blends of
unsaturated δ-lactones or perfumes containing unsaturated lactones.

| | 0.016 | 0.4 | 10 |
|---|---|---|---|
| | mg/mL | mg/mL | mg/mL |
| 6-hex-3-enyloxan-2-one (32%) + 6-hex-4- | 0% | 64% | 100% |
| enyloxan-2-one (12%) + 6-hex-2-enyloxan-2- | | | |
| one (48%) | | | |
| 5-(2-buten-1-yl)-3-methyldihydro-2(3H)- | 11% | 51% | 97% |
| furanone (72%) + 5-(1-buten-1-yl)-3- | | | |
| methyldihydro-2(3H)-furanone (15%) | | | |
| 5-(3-hexen-1-yl)-3-methyldihydro-2(3H)- | 0% | 100% | 92% |
| furanone (60%) + 5-(4-hexen-1-yl)-3- | | | |
| methyldihydro-2(3H)-furanone (40%) | | | |
| 6-pent-3-enyloxan-2-one (1.9%) in a perfuming | 27% | 60% | 87% |
| composition comprising 26 other ingredients | | | |
| 6-pent-3-enyloxan-2-one (1.4%) in a perfuming | 67% | 51% | 84% |
| composition comprising 48 other ingredients | | | |
| 6-pent-3-enyloxan-2-one (0.014%) in a | 0% | 66% | 90% |
| perfuming composition comprising 182 other | | | |
| ingredients | | | |
| 6-pent-3-enyloxan-2-one (0.004%) in a | 1% | 51% | 89% |
| perfuming composition comprising 184 other | | | |
| ingredients | | | |
| 6-pent-2-enyloxan-2-one (10%) + 5-hex-3- | 7% | 64% | 100% |
| enyloxolan-2-one (1%) in a perfuming | | | |
| composition comprising 28 other ingredients | | | |

### 2.2 Results of Arm in Cage Assay for Mosquito: Large Scale Assay to Assess Deterrence and Spatial Repellence

Based on the arm in cage test, the repellence lastingness of different compounds can be evaluated.

It has been found that a 20% solution of 5-hex-3-enyloxolan-2-one diluted in ethanol managed to elicit a mosquito protection >90% during 2 h for Ae. aegypti and during 5 h for An. gambiae (see Table 7). This unsaturated C₁₀ γ-lactone even obtained a 100% protection, i.e. no mosquito landing, during 4 h when tested against An. gambiae (see Table 7).

The untreated arm received 416 mosquito landings in Ae. aegypti experiment and 40 mosquito landings An. gambiae experiments during the 3 min testing period. For the sake of human volunteers, test was stopped when repellency falls below 90%. n.d. is indicated if no measure was made.

TABLE 7
Arm-in-cage repellence overtime of arm treated with 20% of 5-hex-3-enyloxolan-2-one.

| | Time post application of 5-hex-3-enyloxolan-2-one (20% in ethanol) | | | | | | | |
|---|---|---|---|---|---|---|---|---|
| | 5 min | 30 min | 1 h | 2 h | 3 h | 4 h | 5 h | 6 h |
| Ae. aegypti | 98.5% ± | n.d. | 97.0% ± | 93.0% ± | 88.3% ± | 79.5% ± | n.d. | n.d. |
| | 1.1% | | 0.7% | 1.2% | 4.1% | 7.1% | | |
| An. gambiae | n.d. | 100% ± | 100% ± | 100% ± | 100% ± | 100% ± | 97.85% ± | 80.07% ± |
| | | 0% | 0% | 0% | 0% | 0% | 3.7% | 17.6% |

As already observed with the Warm Body Assay, the unsaturated C₁₀ δ-lactones 6-pent-2-enyloxan-2-one and 6-pent-3-enyloxan-2-one were more efficient to repel the mosquitoes Ae. aegypti in the Arm-in-Cage test than the saturated C₁₀ δ-lactone 6-pentyloxan-2-one (paired t-test, p=0.04 and p=0.05 respectively; see FIG. 5).

A-lactones were also found to be efficient to repel An. gambiae; 6-pent-2-enyloxan-2-one and 6-pent-3-enyloxan-2-one allowing 6 h and 8 h, respectively, of repellence >90% (see Table 8). These compounds diluted at 20% in ethanol even obtained a 100% protection against An. gambiae, i.e. no mosquito landing, during 4 h and 3 h, respectively (see Table 8).

Even at a dilution of 5%, 6-pent-2-enyloxan-2-one displayed a repellent effect of 100%±0%, 99.2%±1.3%, 67.2%+7.9%, 30 min, 1 h and 2 h after application, respectively against An. gambiae.

In Table 8, each time point value represents the mean±SD percentage of repellence compared to untreated arm for three distinct human volunteers. Untreated arm received 56 and 40 mosquito landings during the 3 min testing period for 6-pent-2-enyloxan-2-one and 6-pent-3-enyloxan-2-one experiments, respectively. For the sake of human volunteers, test was stopped when repellency falls below 90% and n.d. is indicated.

TABLE 8
Arm-in-cage repellence overtime of arm treated with 20%
of unsaturated δ-lactones against Anopheles gambiae.

| | 30 min | 1 h | 2 h | 3 h | 4 h | 5 h | 6 h | 7 h | 8 h |
|---|---|---|---|---|---|---|---|---|---|
| 6-pent- | 100% ± | 100% ± | 100% ± | 100% ± | 100% ± | 99.2% ± | 92.3% ± | 87.8% ± | n.d. |
| 2-enyloxolan- | 0% | 0% | 0% | 0% | 0% | 0.7% | 4.0% | 7.5% | |
| 2-one | | | | | | | | | |
| 6-pent- | 100% ± | 100% ± | 100% ± | 100% ± | 99.0% ± | 98.4% ± | 98.3% ± | 94.9% ± | 94.7% ± |
| 3-enyloxolan- | 0% | 0% | 0% | 0% | 1.7% | 1.4% | 1.6% | 2.4% | 1.8% |
| 2-one | | | | | | | | | |

As displayed in Table 9, 3,6-dimethyl-3a,4,5,6,7,7a-hexahydro-3H-1-benzofuran-2-one managed to repel >95% of both species of mosquitoes for at least 1 h.

In Table 9, each time point value represents the mean±SD percentage of repellence compared to untreated arm for three distinct human volunteers. The untreated arm received 474.8 mosquito landings in Ae. aegypti experiment with 3,6-dimethyl-3a,4,5,6,7,7a-hexahydro-3H-1-benzofuran-2-one. The untreated arm received 33.8 mosquito landings in An. gambiae experiment with 3,6-dimethyl-3a,4,5,6,7,7a-hexahydro-3H-1-benzofuran-2-one. For the sake of human volunteers, test was stopped when repellency falls below 90%; n.d. is indicated if no measure was made.

TABLE 9
Arm-in-cage repellence overtime of arm treated with
3,6-dimethyl-3a,4,5,6,7,7a-hexahydro-3H-1-benzofuran-
2-one at 20% against Ae. aegypti or An. gambiae.

| | 30 min | 1 h | 2 h | 3 h | 4 h |
|---|---|---|---|---|---|
| Ae. aegypti | 100% ± | 99.93% ± | 92.21% ± | 86.52% ± | 66.02% ± |
| | 0% | 0.12% | 6.95% | 6.28% | 5.41% |
| An. gambiae | 100% ± | 93.7% ± | 67.05% ± | n.d. | n.d. |
| | 0% | 8.62% | 12.6% | | |

### 2.3 Results of Warm Plate Assay for Ticks

Three C₁₀ unsaturated lactones tested were efficient to repel the ticks Ixodes ricinus. As displayed in Table 10, at a concentration of 1%, all three compounds repel all tested ticks, i.e. preventing twelve ticks to walk up and find a settling spot. 6-Pent-3-enyloxan-2-one and 6-pent-2-enyloxan-2-one that were tested with more granularity (see Table 10) already reached this 100% of repellent efficacy at lower doses, i.e. 0.2% and even 0.089% respectively. These two unsaturated C₁₀ δ-lactones even managed to repel >75% at a lower concentration of 0.04% (see Table 10).

In Table 10, the control (0 mg/mL) was made with pure ethanol (used as solvent) applied to the warm plate. n.d. indicates that no test was carried at this specific concentration.

TABLE 10
Percentage of repellence of ticks Ixodes ricinus on the warm plate
baited with C₁₀ unsaturated lactones at different concentrations.

| | 0 | 0.08 | 0.18 | 0.40 | 0.89 | 2 | 10 |
|---|---|---|---|---|---|---|---|
| | mg/mL | mg/mL | mg/mL | mg/mL | mg/mL | mg/mL | mg/mL |
| 5-hex-3-enyloxolan-2-one | 8% | n.d. | n.d. | 17% | n.d. | n.d. | 100% |
| 6-pent-2-enyloxan-2-one | 4% | 33% | 42% | 75% | 100% | 100% | 100% |
| 6-pent-3-enyloxan-2-one | 0% | n.d. | n.d. | 83% | n.d. | 100% | 100% |

1. An arthropod control composition comprising a compound selected from the group consisting of formulae 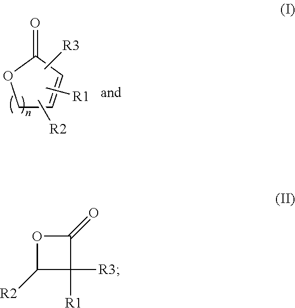
wherein R1 represents a hydrogen, or a linear or branched C₁-C₁₅ hydrocarbon group with 0-2 unsaturations;
wherein R2 represents a hydrogen, or a linear or branched C₁-C₁₅ hydrocarbon group with 0-3 unsaturations; or
wherein R1 and R2, when taken together, form a cycloalkyl-, cycloalkenyl-, or aryl ring that is optionally substituted with one or more methyl or ethyl groups;
wherein n is an integer of from 1 to 3;
wherein R3 represents a hydrogen, or a linear or branched C₁-C₁₅ hydrocarbon group with 0-3 unsaturations;
wherein the dotted line in formula (I) indicates that a double bond may be present in the lactone ring at any position.

2. The composition of claim 1, wherein n is an integer of 1 or 2.

3. The composition of claim 1, wherein the compound of formula (I) is selected from the group of formulae

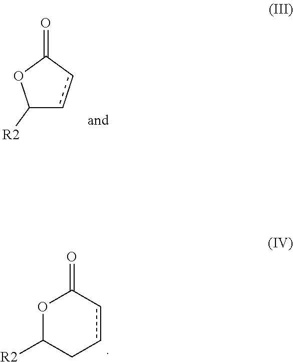

4. The composition of claim 3, wherein the compound of formula (I) is selected from the group of formulae

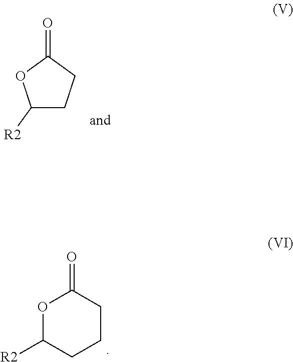

5. The composition of claim 1, wherein R1 and R3 are hydrogens; and R2 represents a linear or branched C₁-C₁₅ hydrocarbon group with from 1 to 3 unsaturations, or R2 represents a C₇-C₁₀ hydrocarbon group without unsaturations.

6. The composition of claim 5, wherein R2 represents a linear or branched C₈-C₁₂ hydrocarbon group with 1 unsaturation.

7. The composition of claim 1, wherein the compound comprises 5-but-3-enyloxolan-2-one, 5-pent-1-enyloxolan-2-one, 5-pent-2-enyloxolan-2-one, 5-pent-3-enyloxolan-2-one, 5-hex-1-enyloxolan-2-one, 5-hex-2-enyloxolan-2-one, 5-hex-3-enyloxolan-2-one, 5-hex-4-enyloxolan-2-one, 5-hex-5-enyloxolan-2-one, 5-oct-1-enyloxolan-2-one, 5-oct-2-enyloxolan-2-one, 5-oct-3-enyloxolan-2-one, 5-oct-4-enyloxolan-2-one, 5-oct-5-enyloxolan-2-one, 5-oct-6-enyloxolan-2-one, 5-oct-7-enyloxolan-2-one, 5-[octa-1,5-dienyl]oxolan-2-one, 6-pent-2-enyloxan-2-one, 6-pent-3-enyloxan-2-one, 6-hex-2-enyloxan-2-one, 6-hex-3-enyloxan-2-one, 6-hex-4-enyloxan-2-one, 6-(hex-3-ynyl)tetrahydro-2H-pyran-2-one, 3-buta-1,3-dienyl-4-pentyloxetan-2-one, 7-but-3-enyloxepan-2-one, 7-pent-4-enyloxepan-2-one, 2-pentyl-2H-furan-5-one, 5-pentyl-3,4-dihydro-2H-pyran-2-one, 5-hexyl-3,4-dihydro-2H-pyran-2-one, 5-heptyl-3,4-dihydro-2H-pyran-2-one, 5-(4-hexen-1-yl)-3-methyldihydro-2(3H)-furanone, 5-(3-hexen-1-yl)-3-methyldihydro-2(3H)-furanone, 4-methyl-5-pentyloxolan-2-one 5-hexyl-5-methyloxolan-2-one, 5-hex-3-enyl-5-methyloxolan-2-one, 1-oxaspiro[4.5]decan-2-one, 3,6-dimethyl-3a,4,5,6,7,7a-hexahydro-3H-1-benzofuran-2-one, 3-propylidene-2-benzofuran-1-one, 5-[(E)-oct-5-enyl]oxolan-2-one, 5-[(Z)-oct-5-enyl]oxolan-2-one, 5-[(1E,5Z)-octa-1,5-dienyl]oxolan-2-one and 4,4,7a-trimethyl-3a,5-dihydro-3H-1-benzofuran-2-one, or any combination thereof.

8. The composition of claim 7, wherein the compound comprises 5-hex-3-enyloxolan-2-one, 6-pent-2-enyloxan-2-one, 6-pent-3-enyloxan-2-one, 4-methyl-5-pentyloxolan-2-one, 5-hexyl-5-methyloxolan-2-one, 1-oxaspiro[4.5]decan-2-one, 3,6-dimethyl-3a,4,5,6,7,7a-hexahydro-3H-1-benzofuran-2-one, 3-propylidene-2-benzofuran-1-one, or any combination thereof.

9. The composition of claim 1, wherein the composition further comprises at least one perfuming ingredient.

10. The composition of claim 1, wherein the composition comprises the compound in an amount of from 0.00032 to 20 wt. %, based on the total weight of the composition.

11. The composition of claim 1, wherein the arthropod is an insect or the arthropod is an arachnid.

12. The composition of claim 1, further comprising an arthropod control co-ingredient comprising N,N-diethyl-3-methylbenzamide (DEET), ethyl butylacetylaminopropionate (IR3535); para-menthan-3,8-diol (PMD); 1-(1-methylpropoxycarbonyl)-2-(2-hydroxaethyl)piperidin (picaridin); Cedarwood oil China, Cedarwood oil Texas, Cedarwood oil Virginia, Cinnamon oil, Citronella oil, Cornmint oil, Cymbopogon winterianus oil fractionated hydrated cyclized, decanoic acid, Eucalyptus citriodora oil, Eucalyptus citriodora oil hydrated cyclized, eugenol, Garlic oil, geraniol, Geranium oil, Lavender oil, Lavandula hybrida oil, Lavandin oil, Lemon oil, Lemongrass oil, Margosa extract, Metofluthrin, mixture of cis- and trans-p-menthane-3,8 diol, N,N-diethyl-meta-toluamide, nonanoic acid, Rosemary oil, Thyme oil, Wintergreen oil, 2,3,4,5-bis(butyl-2-ene)tetrahydrofurfural (MGK Repellent 11), cineole, cinnamaldehyde, citronellal, citronellol, coumarin, dibutyl phthalate, diethyl phthalate, dimethyl anthranilate, dimethyl phthalate, ethyl vanillin, Eucalyptus oil, hydroxy citronellal, Lime oil, limonene, linalool, methyl anthranilate, Mint oil, myrcene, Neem oil, sabinene, 0-caryophyllene, (1H-indol-2-yl)acetic acid, anethole, Anise oil, Basil oil, Bay oil, camphor, ethyl salicylate, Evergreen oils (pine oil), Clove oil, nootkatone, 2-undecanone, sulcatone, (1,3,4,5,6,7-hexahydro-1,3-dioxo-2H-isoindol-2-yl)methyl 2,2-dimethyl-3-(2-methylprop-1-enyl)cyclopropanecarboxylate (d-Tetramethrin), 3-Allyl-2-methyl-4-oxocyclopent-2-enyl-2,2-dimethyl-3-(2-methylprop-1-enyl)-cyclopropanecarboxy late (d-Allethrin), α-cyano-3-phenoxybenzyl, 3-(2,2-dichlorovinyl)-2,2-dimethylcyclopropanecarboxylate (Cypermethrin), 2-methyl-4-oxo-3-(prop-2-ynyl)cyclopent-2-en-1-yl 2,2-dimethyl-3-(2-methylprop-1-enyl)cyclopropanecarboxylate (Prallethrin), acetamiprid, azadirachtin, bendiocarb, bifenthrin, boric acid, chlorpyrifos, deltamethrin, diazinon, dichlorvos, eugenol, fipronil, imidacloprid, malathion, maltodextrin, metofluthrin, nicotine, permethrin, pyrethrins, pyrethroids, rotenone, silicium dioxide (Kieselguhr), S-methoprene, spinosad (Spinosyn A), spinosyn D, tetramethrin, transfluthrin, 1-(2,6,6-trimethylcyclohex-2-en-1-yl)but-2-en-1-one, 3-butylidene-2-benzofuran-1-one, 4-ethenyl-2-methoxyphenol, Cognac oil green, Labdanum extract (Cistus spp.), 5-pentyloxolan-2-one, chromen-2-one, 3,7-dimethylocta-2,6-dienal, 4-hydroxy-3-methoxybenzaldehyde, 2-methyl-5-prop-1-en-2-ylcyclohex-2-en-1-one, Mentha spicata oil, 6-hexyloxan-2-one, 5-methyl-2-propan-2-ylcyclohexyl]acetate, Nigella damascena oil, 2-phenylethanol, 6-pentyloxan-2-one, (4-methoxyphenyl)methyl acetate, Syzygium aromaticum oil, 3,4,4a,5,6,7,8,8a-octahydrochromen-2-one, 3,7,7-trimethylbicyclo[4.1.0]hept-3-ene, 2-phenylethyl 2-methylpropanoate, methyl 2-(3-oxo-2-pent-2-enylcyclopentyl)acetate, 4-(2-methoxypropan-2-yl)-1-methylcyclohexene, Mentha piperita oil, 2-methoxy-4-[prop-1-enyl]phenol, 2-methyl-3-(4-propan-2-ylphenyl)propanal, (4-methoxyphenyl)methanol, 2,3-dihydro-1H-indene-2-carbonitrile, 2,4-dimethyl-4,4a,5,9b-tetrahydroindeno[1,2-d][1,3]dioxine, 2,4-dimethyl-4,4a,5,9btetrahydroindeno[1,2-d][1,3]dioxine, (2,5-dimethyl-2,3-dihydro-1H-inden-2yl)methanol, (4aRS,9bRS)-4a,7-dimethyl-4,4a,5,9b-tetrahydroindeno[1,2-d][1,3]dioxine, (2RS,4aRS,9bRS)-2,4a,7-trimethyl-4,4a,5,9b-tetrahydroindeno[1,2-d][1,3]dioxine (2RS,4aSR,9bSR)-2,4a,7-trimethyl-4,4a,5,9b-tetrahydroindeno[1,2-d][1,3]dioxine, (2-methyl-1,3-dihydroinden-2-yl)methanol, 2,3-dihydro-1H-inden-2-ylmethanol, (2RS,4RS,4ASR,9BRS)-2,4-dimethyl-4,4a,5,9b-tetrahydroindeno[1,2-d][1,3]dioxine, (2RS,4aRS,9bSR)-2-methyl-4,4a,5,9b-tetrahydroindeno[1,2-d][1,3]dioxin (2RS,4aSR,9bRS)-2-methyl-4,4a,5,9b-tetrahydroindeno[1,2-d][1,3]dioxin, (4aRS,9bSR)-2,2-dimethyl-4,4a,5,9b-tetrahydroindeno[1,2-d][1,3]dioxin, (2,4,6-trimethyl-2,3-dihydro-1H-inden-2-yl)methanol, 5-(tert-butyl)-1,3-dihydrospiro[indene-2,3′-oxetane], (2RS,4RS,4ARS,9BSR)-2,4-dimethyl-4,4a,5,9b-tetrahydroindeno[1,2-d][1,3]dioxine, 4A,8-dimethyl-indano[1,2-d]-1,3-dioxan-2-one, 1-(2,5-dimethyl-2,3-dihydro-1H-inden-2-yl)ethanone, (5-methyl-2,3-dihydro-1H-inden-2-yl)methanol, (4aRS,9bSR)-8-methyl-4,4a,5,9b-tetrahydroindeno[1,2-d][1,3]dioxin, (2RS,4aRS,9bSR)-2-ethyl-4,4a,5,9b-tetrahydroindeno[1,2-d][1,3]dioxine (2RS,4aSR,9bRS)-2-ethyl-4,4a,5,9b-tetrahydroindeno[1,2-d][1,3]dioxine, (2R,4aS,9bS)-2,4a,8-trimethyl-4,4a,5,9b-tetrahydroindeno[1,2-d][1,3]dioxin, 1-(2,5-dimethyl-2-indanyl)-1-ethanol, (2,5-dimethyl-2,3-dihydro-1H-inden-2yl)methanol, (2RS,4aRS,9bSR)-2,8-dimethyl-4,4a,5,9b-tetrahydroindeno[1,2-d][1,3]dioxine (2RS,4aSR,9bRS)-2,8-dimethyl-4,4a,5,9b-tetrahydroindeno[1,2-d][1,3]dioxine, (2RS,4aSR,9bSR)-2,4a-dimethyl-4,4a,5,9b-tetrahydroindeno[1,2-d][1,3]dioxin, (4aRS,9bRS)-4a,8-dimethyl-4,4a,5,9b-tetrahydroindeno[1,2-d][1,3]dioxin, 1-(2,4,5-trimethyl-2,3-dihydro-1H-inden-2-yl)ethenone, (2RS,4aRS,9bSR)-2-ethyl-8-methyl-4,4a,5,9b-tetrahydroindeno[1,2-d][1,3]dioxin, (2RS,4aSR,9bRS)-2-ethyl-8-methyl-4,4a,5,9b-tetrahydroindeno[1,2-d][1,3]dioxin, (4aRS,9bRS)-2,2,4a,8-tetramethyl-4,4a,5,9b-tetrahydroindeno[1,2-d][1,3]dioxine, 5-tert-butyl-indan-2-spiro-3′-oxetane, (2,6-dimethyl-1,2,3,4-tetrahydro-2-naphthalenyl)methanol, (4aRS,9bRS)-2,2,4atrimethyl-4,4a,5,9b-tetrahydroindeno[1,2-d][1,3]dioxine, (4aRS,9bRS)-2,2,4a,7-tetramethyl-4,4a,5,9b-tetrahydroindeno[1,2-d][1,3]dioxine, 3-(3/4-ethylcyclopent-1-en-1-yl)-2-methylpropanal, 3-(3/4-propylcyclopent-1-en-1-yl)-2-methylpropanal, 3-(3/4-butylcyclopent-1-en-1-yl)-2-methylpropanal, 3-(3/4-isopropylcyclopent-1-en-1-yl)-2-methylpropanal, 3-(3/4-(sec-butyl)cyclopent-1-en-1-yl)-2-methylpropanal, 3-(3/4-(tert-butyl)cyclopent-1-en-1-yl)-2-methylpropanal, 3-[4-(2-methoxy-2-propanyl)-2-methylphenyl]propanal, 3-[4-(2-hydroxy-2-methylpropyl)phenyl]propanal, 3-(4-tert-butyl-2-methylphenyl)propanal, 3-(4-tert-butylphenyl)propanal, 3-(3-propan-2-ylphenyl)butanal, 3-(4-methoxyphenyl)-2-methylpropanal, 2,6-dimethoxy-4-[prop-1-enyl]phenol, 4-allyl-2,6-dimethoxyphenol, 1,2,3-trimethoxy-5-[1-propen-1-yl]benzene, 1,2,3-trimethoxy-5-propylbenzene, 1,2,4-trimethoxybenzene, 2,6-dimethoxy-4-propylphenol, 2,6-dimethoxy-4-methylphenol, 3-(3,4,5-trimethoxyphenyl)prop-2-enoic acid, 2-(4-hydroxy-3-methoxyphenyl)acetic acid, methyl 3-(3,4-dimethoxyphenyl)-2-methylpropanoate, (2,3-dimethoxyphenyl)methanol, 2,3,4-trimethoxybenzaldehyde, 3,4,5-trimethoxybenzaldehyde, 2-ethoxy-4-(methoxymethyl)phenol, 2-ethoxy-4-(ethoxymethyl)phenol, 1,2-dimethoxy-4-prop-1-enylbenzene, 1,2,3-trimethoxy-5-methylbenzene, 2,6-dimethoxy-4-methylphenol, 1-(2,3,4-trimethoxyphenyl)ethanone, 7-methyl-1,5-benzodioxepin-3-one, 1,2-dimethoxy-3-prop-1-enylbenzene, 1,2,3-trimethoxy-5-propylbenzene, 2,3,4-trimethoxybenzonitrile, 3-ethoxy-4-methoxybenzaldehyde, 2,3,4-trimethoxyphenol, 1-(4-hydroxy-3-methoxyphenyl)ethanone, 2-methoxy-4-(4-methylideneoxan-2-yl)phenol, 4-(3,6-dihydro-4-methyl-2H-pyran-2-yl)-2-methoxy-phenol, 3-(4-isopropyl-2-methylphenyl)propanal, 3-(2-isopropyl-4-methylphenyl)propanal, or mixtures thereof.

13. A method for arthropod control, comprising bringing an arthropod into direct contact or in contact with vapors of a composition as defined in claim 1.

14. (canceled)

15. A consumer product comprising the composition according to claim 1.
